(19) United States
(12) Patent Application Publication
(10) Pub. No.: US 2021/0355336 A1
(43) Pub. Date: Nov. 18, 2021

(54) INK JET INK COMPOSITION FOR POLYVINYL CHLORIDE BUILDING MATERIAL, IMAGE RECORDING METHOD, AND IMAGE RECORDED ARTICLE

(71) Applicant: FUJIFILM CORPORATION, Tokyo (JP)

(72) Inventor: Katsumi ARAKI, Kanagawa (JP)

(21) Appl. No.: 17/389,344

(22) Filed: Jul. 30, 2021

Related U.S. Application Data
(63) Continuation of application No. PCT/JP2019/045641, filed on Nov. 21, 2019.

(30) Foreign Application Priority Data
Feb. 27, 2019 (JP) 2019-033755

(51) Int. Cl. C09D 11/38; C09D 11/322; C09D 11/36; C09D 11/033; C09D 11/037; C09D 11/101; C09D 11/107; B41M 5/00

(52) U.S. Cl. CPC C09D 11/38; C09D 11/322; C09D 11/36; B41M 5/0023; C09D 11/037; C09D 11/101; C09D 11/107; C09D 11/033

(57) ABSTRACT

Provided are an ink jet ink composition for a polyvinyl chloride building material, an image recording method, and an image recorded article. The ink jet ink composition contains a monomer A that is a polymerizable monomer having a basic group including a nitrogen atom and an inorganic pigment including at least one element selected from the group consisting of cobalt, aluminum, iron, bismuth, vanadium, titanium, and carbon.

### CROSS-REFERENCE TO RELATED APPLICATIONS

This application is a continuation application of International Application No. PCT/JP2019/045641, filed Nov. 21, 2019, the disclosure of which is incorporated herein by reference in its entirety. Further, this application claims priority from Japanese Patent Application No. 2019-033755, filed Feb. 27, 2019, the disclosure of which is incorporated herein by reference in its entirety.

### BACKGROUND OF THE INVENTION

### 1. Field of the Invention

The present disclosure relates to an ink jet ink composition for a polyvinyl chloride building material, an image recording method, and an image recorded article.

### 2. Description of the Related Art

Various studies have been conducted on inks used for the recording of images.

For example, JP2008-201876A discloses an ink composition that has reliable long-term storage stability, has high continuous ejectability, provides an image with an excellent hue after being cured, and has high adhesion to a substrate. The ink composition contains (A) an N-vinyl lactam, (B) another polymerizable compound, (C) a polymerization initiator, and (D) a basic compound, (A) the N-vinyl lactam being contained in an amount of less than 15 wt % of the total weight of the ink composition.

JP2014-47236A discloses an ink composition for ink jet recording that can provide printed matter with high weather resistance. The ink composition for ink jet recording contains C.I. pigment yellow 42 (PY42), a basic high molecular weight dispersant, a polymerization initiator, and a polymerizable compound. The PY42 has a pH of 3 to 6, and the basic high molecular weight dispersant has an amine value of 10 to 45 mgKOH/g.

JP2009-149719A discloses an ink jet yellow ink that has a deep color, high ink stability, and high weather resistance so as to be usable for outdoor materials such as siding materials. The ink jet yellow ink contains (a) C.I. pigment yellow 42 as a yellow pigment and (b) C.I. pigment red 101.

### SUMMARY OF THE INVENTION

However, none of JP2008-201876A, JP2014-47236A, and JP2009-149719A takes into account the recording of an image on a polyvinyl chloride building material and the adhesiveness over time and rubfastness over time of the image in this case in an outdoor environment.

An object of one aspect of the present disclosure is to provide an ink jet ink composition for a polyvinyl chloride building material, an image recording method, and an image recorded article. The ink jet ink composition enables recording of an image having high adhesiveness over time and high rubfastness over time in an outdoor environment on a polyvinyl chloride building material. The image recorded article includes a polyvinyl chloride building material and an image having high adhesiveness over time and high rubfastness over time in an outdoor environment.

Specific means for achieving the object include the following aspects.

<1> An ink jet ink composition for a polyvinyl chloride building material contains a monomer A that is a polymerizable monomer having a basic group including a nitrogen atom and an inorganic pigment including at least one element selected from the group consisting of cobalt, aluminum, iron, bismuth, vanadium, titanium, and carbon.
<2> In the ink jet ink composition for a polyvinyl chloride building material according to <1>, the basic group including a nitrogen atom is a tertiary amino group.
<3> In the ink jet ink composition for a polyvinyl chloride building material according to <1> or <2>, the basic group including a nitrogen atom is an aliphatic amino group.
<4> In the ink jet ink composition for a polyvinyl chloride building material according to any one of <1> to <3>, the inorganic pigment is at least one selected from the group consisting of C.I. pigment blue 28, C.I. pigment red 101, C.I. pigment yellow 42, C.I. pigment yellow 184, C.I. pigment white 6, and C.I. pigment black 7.
<5> The ink jet ink composition for a polyvinyl chloride building material according to any one of <1> to <4> further contains a monomer B that is a (meth)acrylate compound having an aromatic ring.
<6> The ink jet ink composition for a polyvinyl chloride building material according to any one of <1> to <5> further contains a monomer C that is N-vinylcaprolactam.
<7> The ink jet ink composition for a polyvinyl chloride building material according to any one of <1> to <4> further contains a monomer B that is a (meth)acrylate compound having an aromatic ring and a monomer C that is N-vinylcaprolactam. In the ink jet ink composition, the ratio of the mass content of the monomer A to the total mass content of the monomer B and the monomer C is 0.004 to 1.
<8> The ink jet ink composition for a polyvinyl chloride building material according to any one of <1> to <7> further contains a monomer D that is a polymerizable monomer having an alicyclic structure.
<9> The ink jet ink composition for a polyvinyl chloride building material according to any one of <1> to <8> further includes at least one selected from the group consisting of a monomer E that is a polymerizable monomer having an epoxy ring, a monomer F that is a polymerizable monomer having an oxetane ring, and a monomer G that is a polymerizable monomer containing a fluorine atom.
<10> The ink jet ink composition for a polyvinyl chloride building material according to any one of <1> to <9> further contains a compound H that is at least one selected from the group consisting of organic solvents, alkyl (meth)acrylates having an alkyl group of 1 to 4 carbon atoms, and styrene optionally having a substituent other than a fluorine atom.
<11> In the ink jet ink composition for a polyvinyl chloride building material according to <10>, the content of the compound H is 0.05 mass % to 35 mass % relative to the total content of all polymerizable monomers contained in the ink jet ink composition for a polyvinyl chloride building material.
<12> The ink jet ink composition for a polyvinyl chloride building material according to any one of <1> to <11> further contains a photopolymerization initiator.
<13> An image recording method has a step of applying the ink jet ink composition for a polyvinyl chloride building material according to any one of <1> to <12> to a polyvinyl chloride building material by an ink jet method and a step of irradiating the ink jet ink composition for a polyvinyl chloride building material applied to the polyvinyl chloride building material with an active radiation.
<14> An image recorded article includes a polyvinyl chloride building material and an image disposed on the polyvinyl chloride building material. The image is a cured product of the ink jet ink composition for a polyvinyl chloride building material according to any one of <1> to <12>.

According to one aspect of the present disclosure, an ink jet ink composition for a polyvinyl chloride building material, an image recording method, and an image recorded article are provided. The ink jet ink composition enables recording of an image having high adhesiveness over time and high rubfastness over time in an outdoor environment on a polyvinyl chloride building material. The image recorded article includes a polyvinyl chloride building material and an image having high adhesiveness over time and high rubfastness over time in an outdoor environment.

### DESCRIPTION OF THE PREFERRED EMBODIMENTS

In the present disclosure, a numerical range expressed using “to” means a range including numerical values before and after “to” as lower and upper limit values.

In the present disclosure, if there are two or more substances corresponding to one component in a composition, the amount of the component in the composition means the total amount of the two or more substances present in the composition unless otherwise specified.

In numerical ranges described in stages in the present disclosure, the upper limit value or the lower limit value described in one numerical range may be replaced with the upper limit value or the lower limit value of other numerical ranges described in stages or may be replaced with values described in Examples.

In the present disclosure, the term “step” encompasses not only an independent step but also a step that is not clearly distinguished from another step if the desired object of the step is achieved.

In the present disclosure, a combination of preferred embodiments is a more preferred embodiment.

In the present disclosure, “light” is a concept that encompasses active radiations such as γ-rays, β-rays, electron beams, ultraviolet radiation, and visible radiation.

In the present disclosure, ultraviolet radiation may be referred to as “UV (ultraviolet) light”.

In the present disclosure, “(meth)acrylic acid” is a concept that encompasses both acrylic acid and methacrylic acid, “(meth)acrylate” is a concept that encompasses both acrylate and methacrylate, “(meth)acrylamide” is a concept that encompasses both acrylamide and methacrylamide, and “(meth)acryloyl group” is a concept that encompasses both an acryloyl group and a methacryloyl group.

In the present disclosure, “C.I.” means a color index.

In the present disclosure, an “ink jet ink composition for a polyvinyl chloride building material” means an ink jet ink composition used for the recording of an image on a polyvinyl chloride building material.

In the present disclosure, a polyvinyl chloride building material means a building material that includes polyvinyl chloride as a raw material.

In the present disclosure, “image” means all types of films formed using an ink jet ink composition for a polyvinyl chloride building material, and “recording of an image” and “image recording” mean the formation of a film and film formation, respectively.

The concept of “image” in the present disclosure also encompasses solid images.

### Ink-Jet Ink Composition for Polyvinyl Chloride Building Material

An ink jet ink composition (hereinafter also referred to simply as “ink”) for a polyvinyl chloride building material of the present disclosure is used for the recording of an image on a polyvinyl chloride building material and contains a polymerizable monomer A that is a polymerizable monomer having a basic group including a nitrogen atom and an inorganic pigment including at least one element selected from the group consisting of cobalt, aluminum, iron, bismuth, vanadium, titanium, and carbon.

According to the ink of the present disclosure, an image having high adhesiveness over time and high rubfastness over time in an outdoor environment can be recorded on a polyvinyl chloride building material.

Here, the adhesiveness over time means adhesiveness between a polyvinyl chloride building material and an image after the passage of time in an outdoor environment.

The rubfastness over time means rubfastness of an image after the passage of time in an outdoor environment.

The adhesiveness over time and the rubfastness over time are basically properties independent of each other but may be correlated with each other. For example, the rubfastness over time may improve as a result of improvement in adhesiveness over time.

The reason why the ink of the present disclosure produces the effects of improving the adhesiveness over time and rubfastness over time of an image is presumably as follows. However, the ink of the present disclosure is not limited by the following reason.

The polyvinyl chloride building material is decomposed due to the passage of time in an outdoor environment to generate hydrochloric acid (HCl), and due to the action of the hydrochloric acid, the adhesiveness over time and rubfastness over time of an image are degraded.

In an image recorded using the ink of the present disclosure, the “basic group including a nitrogen atom” derived from the monomer A traps hydrochloric acid, and as a result, the adhesiveness over time and rubfastness over time of the image in an outdoor environment are reduced.

The ink of the present disclosure contains an inorganic pigment (hereinafter also referred to as a “specific inorganic pigment”) including at least one element selected from the group consisting of cobalt, aluminum, iron, bismuth, vanadium, titanium, and carbon.

The specific inorganic pigment is a pigment having high weather resistance, that is, high durability in an outdoor environment. Thus, the presence of the specific inorganic pigment in the ink of the present disclosure also contributes to the effect of improving the adhesiveness over time and rubfastness over time in an outdoor environment.

### Specific Inorganic Pigment

The ink of the present disclosure contains at least one specific inorganic pigment (i.e., inorganic pigment including at least one element selected from the group consisting of cobalt, aluminum, iron, bismuth, vanadium, titanium, and carbon).

The specific inorganic pigment may be a known pigment (e.g., a pigment described in the color index (C.I.)).

From the viewpoint of adhesiveness over time and rubfastness over time, among specific inorganic pigments, at least one selected from the group consisting of C.I. pigment blue 28, C.I. pigment red 101, C.I. pigment yellow 42, C.I. pigment yellow 184, C.I. pigment white 6, and C.I. pigment black 7 is preferred.

### Pigment Blue 28

C.I. pigment blue 28 (hereinafter also referred to simply as PB28) is a cyan inorganic pigment composed of cobalt aluminate. Any type of PB28 can be used for the ink of the present disclosure, and the following commercially available products of PB28 are suitable for use.

Examples of commercially available products of PB28 include Luconyl EH0843, Sicopal L6210, Sicopal K6310, and Xfast 6310 (manufactured by BASF).

### Pigment Red 101

C.I. pigment blue 101 (hereinafter also referred to simply as PR101) is a magenta inorganic pigment composed of iron oxide (III). Any type of PR101 can be used for the ink of the present disclosure, and the following commercially available products of PR101 are suitable for use.

Examples of commercially available products of PR101 include Sicotrans L2715, Sicotrans L2816, Sicotrans L2817, Sicotrans L2818, Sicotrans L2915 (manufactured by BASF), Cappoxyt Red 4434B, Cappoxyt Red 4435B, Cappoxyt Red 4437B, and Cappoxyt Red 4438B (manufactured by Cappelle).

### Pigment Yellow 42

C.I. pigment yellow 42 (hereinafter also referred to simply as PY42) is a yellow inorganic pigment composed of iron oxide. Any type of PY42 can be used for the ink of the present disclosure, and the following commercially available products of PY42 are suitable for use.

Examples of commercially available products of PY42 include Sicotrans L1915, Sicotrans L1916 (manufactured by BASF), Cappoxyt Yellow 4212X, and Cappoxyt Yellow 4214X (manufactured by Cappelle).

### Pigment Yellow 184

C.I. pigment yellow 184 (hereinafter also referred to simply as PY184) is a yellow inorganic pigment composed of bismuth vanadate. Any type of PY184 can be used for the ink of the present disclosure, and the following commercially available products of PY184 are suitable for use.

Examples of commercially available products of PY184 include Sicopal L1100, Sicopal L1110, Sicopal L1120, Sicopal L1600 (manufactured by BASF), Lysopac Yellow 6601B, Lysopac Yellow 6611B, Lysopac Yellow 6615B, and Lysopac Yellow 6616B (manufactured by Cappelle).

### Pigment White 6

C.I. pigment white 6 (hereinafter also referred to simply as PW6) is a white inorganic pigment composed of titanium oxide. Any type of PW6 can be used for the ink of the present disclosure, and the following commercially available products of PW6 are suitable for use.

Examples of commercially available products of PW6 include KRONOS 2300 (manufactured by KRONOS) and TIPAQUE CR60-2 (manufactured by Ishihara Sangyo Kaisha, Ltd.).

### Pigment Black 7

C.I. pigment black 7 (hereinafter also referred to simply as PBK7) is a black inorganic pigment containing carbon (specifically, carbon black). Any type of PBK7 can be used for the ink of the present disclosure, and the following commercially available products of PBK7 are suitable for use.

Examples of commercially available products of PBK7 include SPECIAL BLACK 250 (manufactured by BASF) and Mogul E (manufactured by Cabot Corporation).

The smaller the average particle size of the specific inorganic pigment, the higher the color developability. The volume-average particle size of the specific inorganic pigment is preferably 0.01 μm to 0.4 μm, more preferably 0.02 μm to 0.3 μm.

In the present disclosure, the volume-average particle size means a value measured with a laser diffraction/scattering particle size distribution analyzer.

One example of a measuring apparatus is a particle size distribution analyzer “Microtrac MT-3300II” (manufactured by Nikkiso Co., Ltd.).

The content of the specific inorganic pigment in the ink of the present disclosure relative to the total amount of the ink is preferably 0.01 mass % to 30 mass %, more preferably 0.1 mass % to 25 mass %, still more preferably 0.1 mass % to 15 mass %. Within this numerical range, the storage stability and color development of the ink are further improved.

The ink of the present disclosure may further include another colorant other than the specific inorganic pigment.

The other colorant may be a known pigment such as a pigment described in the color index. Regarding the other colorant, reference may be made, as appropriate, to known publications such as paragraph 0097 of International Publication No. 2015/115600.

The ink of the present disclosure may contain at least one dispersing agent.

Regarding the dispersing agent, reference can be made, as appropriate, to known publications such as paragraphs 0152 to 0158 of JP2011-225848A and paragraphs 0132 to 0149 of JP2009-209352A.

### Polymerizable Monomer Having Basic Group Including Nitrogen Atom (Monomer A)

The ink of the present disclosure contains at least one monomer A that is a polymerizable monomer having a basic group including a nitrogen atom.

The monomer A is not particularly limited if it has a basic group including a nitrogen atom.

### Basic Group Having Nitrogen Atom

The basic group having a nitrogen atom in the monomer A is not particularly limited.

Examples of the basic group having a nitrogen atom include tertiary amino groups and nitrogen-containing heterocyclic groups.

For further improvement of adhesiveness over time and rubfastness over time, the basic group having a nitrogen atom is preferably a tertiary amino group.

For further improvement of color-difference weather resistance, the basic group having a nitrogen atom is preferably an aliphatic amino group.

Here, the color-difference weather resistance means a hue change (color difference ΔE) of an image after the passage of time in an outdoor environment. Smaller color differences ΔE indicate higher color-difference weather resistance.

For further improvement of adhesiveness over time, rubfastness over time, and color-difference weather resistance, the basic group having a nitrogen atom is preferably a tertiary amino group that is an aliphatic amino group.

Examples of the tertiary amino group that is an aliphatic amino group include dialkylamino groups and alicyclic amino groups having a structure in which two alkyl groups in a dialkylamino group are bonded together directly or through a heteroatom.

The number of carbon atoms in the tertiary amino group that is an aliphatic amino group is preferably 2 to 12, more preferably 2 to 8.

Examples of the tertiary amino group that is an aliphatic amino group include a dimethylamino group, a diethylamino group, a morpholino group, a piperidino group, a pyrrolidino group, and a piperazino group having a substituent on a nitrogen atom.

The monomer A is preferably a radical-polymerizable monomer.

The monomer A in the case of a radical-polymerizable monomer has a basic group having a nitrogen atom and also has a radical-polymerizable group.

The radical-polymerizable group in the radical-polymerizable monomer in the present disclosure is preferably an ethylenically unsaturated group (i.e., a group including an ethylenic double bond), more preferably a vinyl group, an allyl group, or a (meth)acryloyl group, still more preferably a (meth)acryloyl group.

The molecular weight of the monomer A is preferably 1000 or less, more preferably 500 or less, still more preferably 400 or less.

When the monomer A is a radical-polymerizable monomer, the monomer A may be a monofunctional radical-polymerizable monomer (hereinafter also referred to simply as a “monomer A-1”) or a bi- or higher functional radical-polymerizable monomer (hereinafter also referred to simply as a “monomer A-2”), and is more preferably a monomer A-1 from the viewpoint of image adhesion and availability.

Examples of the monomer A-1 include dimethylaminoethyl (meth)acrylate, diethylaminoethyl (meth)acrylate, N-phenylaminoethyl (meth)acrylate, 2-N-morpholinoethyl (meth)acrylate, 2-piperidinoethyl (meth)acrylate, and 2-pyrrolidinoethyl (meth)acrylate.

Examples of the monomer A-2 include reaction products of N-methyldiethanolamine and (meth)acrylic acid and reaction products of piperazine-1,4-bisethanolamine and (meth)acrylic acid.

The monomer A is particularly preferably dimethylaminoethyl (meth)acrylate or diethylaminoethyl (meth)acrylate.

The content of the monomer A relative to the total amount of the ink is preferably 1 mass % to 60 mass %, more preferably 1 mass % to 20 mass %, still more preferably 1 mass % to 10 mass %.

The ratio of the mass content of the monomer A to the total mass content of all polymerizable monomers contained in the ink (hereinafter also referred to as the “monomer A/all monomers ratio”) is preferably 0.001 to 0.9, more preferably 0.002 to 0.5, still more preferably 0.05 to 0.5, even more preferably 0.05 to 0.4.

The preferred range of the ratio of the mass content of the monomer A to the total mass content of all radical-polymerizable monomers contained in the ink is the same as the preferred range of the monomer A/all monomers ratio described above.

### (Meth)Acrylate Compound (Monomer B) Having Aromatic Ring

For further improvement of the rubfastness over time of an image, the ink of the present disclosure preferably contains at least one monomer B that is a (meth)acrylate compound having an aromatic ring.

The monomer B is a radical-polymerizable monomer.

When the ink of the present disclosure contains the monomer B, it is preferred that the monomer A described above be also a radical-polymerizable monomer.

Here, the aromatic ring may be, for example, a benzene ring or a naphthalene ring, and is preferably a benzene ring.

The monomer B is preferably a (meth)acrylate compound having an aromatic ring and not having a basic group including a nitrogen atom.

The molecular weight of the monomer B is preferably 1000 or less, more preferably 500 or less, still more preferably 400 or less.

The monomer B may be a monofunctional (meth)acrylate compound (hereinafter also referred to simply as a “monomer B-1”) or a bi- or higher functional (meth)acrylate compound (hereinafter also referred to simply as a “monomer B-2”).

Examples of the monomer B-1 include phenoxyethyl (meth)acrylate and benzyl (meth)acrylate.

Examples of the monomer B-2 include reaction products of 1,4-bis(2-hydroxyethoxy)benzene and (meth)acrylic acid.

For further improvement of the rubfastness over time of an image, the ink of the present disclosure preferably includes the monomer B-1, more preferably includes phenoxyethyl (meth)acrylate (i.e., includes at least one of phenoxyethyl acrylate or phenoxyethyl methacrylate).

When the ink of the present disclosure contains the monomer B, the content of the monomer B relative to the total amount of the ink is preferably 1 mass % to 50 mass %, more preferably 5 mass % to 45 mass %, still more preferably 10 mass % to 40 mass %.

For further improvement of the rubfastness over time of an image, the ratio of the mass content of the monomer B to the total mass content of all polymerizable monomers contained in the ink (hereinafter also referred to as the “monomer B/all monomers ratio”) is preferably 0.001 to 0.9, more preferably 0.002 to 0.5, still more preferably 0.01 to 0.5, even more preferably 0.05 to 0.4.

The preferred range of the ratio of the mass content of the monomer B to the total mass content of all radical-polymerizable monomers contained in the ink is the same as the preferred range of the monomer B/all monomers ratio described above.

### N-Vinylcaprolactam (Monomer C)

For further improvement of the rubfastness over time of an image, the ink of the present disclosure may further include a monomer C that is N-vinylcaprolactam.

The monomer C is a radical-polymerizable monomer.

When the ink of the present disclosure contains the monomer C, it is preferred that the monomer A described above be also a radical-polymerizable monomer.

When the ink of the present disclosure contains the monomer C, the content of the monomer C relative to the total amount of the ink is preferably 1 mass % to 40 mass %, more preferably 3 mass % to 35 mass %, still more preferably 5 mass % to 30 mass %.

For further improvement of the rubfastness over time of an image, the ratio of the mass content of the monomer C to the total mass content of all polymerizable monomers contained in the ink (hereinafter also referred to as the “monomer C/all monomers ratio”) is preferably 0.001 to 0.9, more preferably 0.002 to 0.5, still more preferably 0.01 to 0.5, even more preferably 0.05 to 0.4.

The preferred range of the ratio of the mass content of the monomer C to the total mass content of all radical-polymerizable monomers contained in the ink is the same as the preferred range of the monomer C/all monomers ratio described above.

When the ink of the present disclosure contains at least one of the monomer B or the monomer C (preferably both), for further improvement of the rubfastness over time of an image, the ratio of the mass content of the monomer B to the total mass content of the monomer B and the monomer C (hereinafter also referred to as the “monomer B/(monomer B+monomer C) ratio”) is preferably 0.1 to 1, more preferably 0.2 to 0.9, still more preferably 0.3 to 0.8.

When the ink of the present disclosure contains at least one of the monomer B or the monomer C (preferably both), the ratio of the mass content of the monomer A to the total mass content of the monomer B and the monomer C (hereinafter also referred to as the “monomer A/(monomer B+monomer C) ratio”) is preferably 0.002 to 5, more preferably 0.004 to 1, still more preferably 0.004 to 0.8, even more preferably 0.004 to 0.6.

When the monomer A/(monomer B+monomer C) ratio is 0.002 or more, the adhesiveness over time and rubfastness over time of an image are further improved.

When the monomer A/(monomer B+monomer C) ratio is 5 or less, the rubfastness over time of an image is further improved.

For further improvement of the adhesiveness over time and rubfastness over time of an image, the ratio of the total mass content of the monomer A, the monomer B, and the monomer C to the total mass content of all polymerizable monomers contained in the ink (hereinafter also referred to as the “(monomer A+monomer B+monomer C)/all monomers ratio”) is preferably 0.3 or more, more preferably 0.4 or more, still more preferably 0.5 or more, even more preferably 0.6 or more.

The (monomer A+monomer B+monomer C)/all monomers ratio may be 1 or may be less than 1.

The preferred range of the ratio of the total mass content of the monomer C to the total mass content of all radical-polymerizable monomers contained in the ink is the same as the preferred range of the (monomer A+monomer B+monomer C)/all monomers ratio described above.

### Polymerizable Monomer Having Alicyclic Structure (Monomer D)

For further improvement of the rubfastness over time of an image, the ink of the present disclosure may further contain at least one monomer D that is a polymerizable monomer having an alicyclic structure.

When the ink of the present disclosure contains the monomer D, the monomer A and the monomer D contained in the ink are each preferably a radical-polymerizable monomer.

The number of carbon atoms in the alicyclic structure of the monomer D is preferably 4 to 20, more preferably 4 to 16, still more preferably 4 to 12.

The alicyclic structure of the monomer D may have a heteroatom in the cyclic structure.

The alicyclic structure of the monomer D is preferably a cycloalkyl group or a heterocycloalkyl group. The number of heteroatoms in the cyclic structure of the heterocycloalkyl group is preferably 1 or 2. The heteroatom in the cyclic structure of the heterocycloalkyl group is preferably an oxygen atom, a sulfur atom, or a nitrogen atom, more preferably an oxygen atom.

The heterocycloalkyl group is preferably a five- or six-membered heterocycloalkyl group.

The monomer D is preferably a polymerizable monomer having an alicyclic structure and not having a basic group including a nitrogen atom or an aromatic ring.

The monomer D is more preferably a (meth)acrylate having an alicyclic structure and not having a basic group including a nitrogen atom, an aromatic ring, an epoxy ring, or an oxetane ring.

When the monomer D is a radical-polymerizable monomer, the monomer D may be a monofunctional radical-polymerizable monomer (hereinafter also referred to simply as a “monomer D-1”) or a bi- or higher functional radical-polymerizable monomer (hereinafter also referred to simply as a “monomer D-2”), and is more preferably a monomer D-1 from the viewpoint of image adhesion and availability.

The molecular weight of the monomer D is preferably 1000 or less, more preferably 500 or less, still more preferably 300 or less.

Examples of the monomer D-1 include cyclic trimethylolpropane formal (meth)acrylate, cyclohexyl (meth)acrylate, isobornyl (meth)acrylate, 2-methyladamantan-2-yl (meth)acrylate, 2-ethyladamantan-2-yl (meth)acrylate, and 1-(meth)acryloyloxy-3-hydroxyadamantane.

Examples of the monomer D-2 include 1,3-bis-(meth)acryloyloxy-adamantane.

When the ink of the present disclosure contains the monomer D, the content of the monomer D relative to the total amount of the ink is preferably 1 mass % to 20 mass %, more preferably 3 mass % to 15 mass %, still more preferably 5 mass % to 10 mass %.

When the ink of the present disclosure contains the monomer D, the ratio of the mass content of the monomer D to the total mass content of all polymerizable monomers contained in the ink (hereinafter also referred to as the “monomer D/all monomers ratio”) is preferably 0.01 to 0.3, more preferably 0.02 to 0.2.

The preferred range of the ratio of the mass content of the monomer D to the total mass content of all radical-polymerizable monomers contained in the ink is the same as the preferred range of the monomer D/all monomers ratio described above.

For further improvement of the adhesiveness over time and rubfastness over time of an image, the ink of the present disclosure preferably further includes at least one selected from the group consisting of a monomer E that is a polymerizable monomer having an epoxy ring, a monomer F that is a polymerizable monomer having an oxetane ring, and a monomer G that is a polymerizable monomer containing a fluorine atom.

### Polymerizable Monomer Having Epoxy Ring (Monomer E)

The ink of the present disclosure may include at least one monomer E that is a polymerizable monomer having an epoxy ring.

The monomer E is preferably a radical-polymerizable monomer.

The monomer E is more preferably a radical-polymerizable monomer having an epoxy ring and not having a basic group including a nitrogen atom or an aromatic ring.

When the monomer E is a radical-polymerizable monomer, the monomer E may be a monofunctional radical-polymerizable monomer (hereinafter also referred to simply as a “monomer E-1”) or a bi- or higher functional radical-polymerizable monomer (hereinafter also referred to simply as a “monomer E-2”), and is preferably a monomer E-1 from the viewpoint of image adhesion and availability.

The molecular weight of the monomer E is preferably 1000 or less, more preferably 500 or less, still more preferably 300 or less.

Examples of the monomer E-1 include glycidyl (meth)acrylate, 4-hydroxybutyl (meth)acrylate glycidyl ether, 3,4-epoxycyclohexylmethyl (meth)acrylate, and allyl glycidyl ether.

The monomer E-1 may also be, for example, a compound derived from a compound having two or more epoxy groups (e.g., a bisphenol A epoxy resin), with (meth)acrylic acid being added to one of the epoxy groups.

For further improvement of rubfastness over time, the monomer E preferably has an alicyclic structure.

In this case, the monomer E may have a fused-ring structure formed of an alicyclic structure and an epoxy ring.

The number of carbon atoms in the alicyclic structure that the monomer E may have is preferably 4 to 20, more preferably 4 to 16, still more preferably 4 to 12.

The alicyclic structure that the monomer E may have is preferably a five- or six-membered alicyclic structure.

The alicyclic structure that the monomer E may have a heteroatom in the cyclic structure.

The alicyclic structure that the monomer E may have is preferably a cycloalkyl group or a heterocycloalkyl group. The number of heteroatoms in the cyclic structure of the heterocycloalkyl group is preferably 1 or 2. The heteroatom in the cyclic structure of the heterocycloalkyl group is preferably an oxygen atom, a sulfur atom, or a nitrogen atom, more preferably an oxygen atom.

The alicyclic structure that the monomer E may have is preferably a cycloalkyl group, more preferably a five- or six-membered cycloalkyl group.

Examples of the monomer E having an alicyclic structure include 3,4-epoxycyclohexylmethyl (meth)acrylate.

When the ink of the present disclosure includes the monomer E, the content of the monomer E relative to the total amount of the ink is preferably 0.1 mass % to 10 mass %, more preferably 0.3 mass % to 5 mass %, still more preferably 0.5 mass % to 3 mass %.

When the ink of the present disclosure contains the monomer E, the ratio of the mass content of the monomer E to the total mass content of all polymerizable monomers contained in the ink (hereinafter also referred to as the “monomer E/all monomers ratio”) is preferably 0.01 to 0.2, more preferably 0.02 to 0.1.

The preferred range of the ratio of the mass content of the monomer E to the total mass content of all radical-polymerizable monomers contained in the ink is the same as the preferred range of the monomer E/all monomers ratio described above.

### Polymerizable Monomer Having Oxetane Ring (Monomer F)

The ink of the present disclosure may include at least one monomer F that is a polymerizable monomer having an oxetane ring.

The monomer F is preferably a radical-polymerizable monomer.

The monomer F is more preferably a radical-polymerizable monomer having, in its molecule, an oxetane ring and not having a basic group including a nitrogen atom, an aromatic ring, a five- or six-membered alicyclic structure, or an epoxy ring.

The monomer F is still more preferably a (meth)acrylate having, in its molecule, an oxetane ring and not having a basic group including a nitrogen atom, an aromatic ring, a five- or six-membered alicyclic structure, or an epoxy ring.

When the monomer F is a radical-polymerizable monomer, the monomer F may be a monofunctional radical-polymerizable monomer (hereinafter also referred to simply as a “monomer F-1”) or a bi- or higher functional radical-polymerizable monomer (hereinafter also referred to simply as a “monomer F-2”), and is preferably a monomer F-1 from the viewpoint of image adhesion and availability.

The molecular weight of the monomer F is preferably 1000 or less, more preferably 500 or less, particularly preferably 200 or less.

Examples of the monomer F-1 include (3-ethyloxetan-3-yl)methyl (meth)acrylate.

The monomer F may have an alicyclic structure.

Preferred embodiments in the case where the monomer F has an alicyclic structure are the same as the preferred embodiments in the case where the monomer E has an alicyclic structure.

When the ink of the present disclosure includes the monomer F, the content of the monomer F relative to the total amount of the ink is preferably 0.1 mass % to 10 mass %, more preferably 0.3 mass % to 5 mass %, still more preferably 0.5 mass % to 3 mass %.

When the ink of the present disclosure contains the monomer F, the ratio of the mass content of the monomer F to the total mass content of all polymerizable monomers contained in the ink (hereinafter also referred to as the “monomer F/all monomers ratio”) is preferably 0.01 to 0.2, more preferably 0.02 to 0.1.

The preferred range of the ratio of the mass content of the monomer F to the total mass content of all radical-polymerizable monomers contained in the ink is the same as the preferred range of the monomer F/all monomers ratio described above.

### Polymerizable Monomer Containing Fluorine Atom (Monomer G)

The ink of the present disclosure may include at least one monomer G that is a polymerizable monomer containing a fluorine atom (hereinafter also referred to simply as “monomer G”).

The monomer G is preferably a radical-polymerizable monomer.

When the monomer G is a radical-polymerizable monomer, the monomer G may be a monofunctional polymerizable monomer (hereinafter also referred to simply as a “monomer G-1”) or a bi- or higher functional polymerizable monomer (hereinafter also referred to simply as a “monomer G-2”), and is preferably a monomer G-1 from the viewpoint of image adhesion and availability.

The molecular weight of the monomer G is preferably 1000 or less, more preferably 750 or less, still more preferably 500 or less.

Examples of the monomer G-1 include (meth)acrylate compounds having a fluoroalkyl group of 1 to 20 carbon atoms, such as
2,2,2-trifluoroethyl (meth)acrylate,
2,2,3,3-tetrafluoropropyl (meth)acrylate,
1,1,1,3,3,3-hexafluoroisopropyl (meth)acrylate,
2,2,3,3,3-pentafluoropropyl (meth)acrylate,
2,2,3,4,4,4-hexafluorobutyl (meth)acrylate,
2,2,3,3,4,4,4-heptafluorobutyl (meth)acrylate,
1H,1H,5H-octafluoropentyl (meth)acrylate,
1H,1H,2H,2H-nonafluorohexyl (meth)acrylate,
1H,1H,2H,2H-tridecafluoro-n-octyl (meth)acrylate,
1H,1H-pentadecafluoro-n-octyl (meth)acrylate,
1H,1H,2H,2H-tridecafluoro-n-octyl (meth)acrylate,
2,2,3,3,4,4,5,5,6,6,7,7-dodecafluoroheptyl (meth)acrylate, and
1H,1H,2H,2H-heptafluorodecyl (meth)acrylate;
(meth)acrylate compounds having a fluoroaryl group of 6 to 20 carbon atoms;
(meth)acrylate compounds having a fluoroaralkyl group of 7 to 20 carbon atoms, such as pentafluorobenzyl (meth)acrylate; and
fluorostyrenes such as 2,3,4,5,6-pentafluorostyrene.

Examples of the monomer G-2 include reaction products (ester compounds) of (meth)acrylic acid and a diol compound having a fluorine atom.

Examples of the diol compound having a fluorine atom include 1,3-bis(hexafluoro-a-hydroxyisopropyl)benzene, 2,2,3,3,4,4,5,5,6,6,7,7-dodecafluoro-1,8-octanediol, 2,2,3,3,4,4-hexafluoro-1,5-pentanediol, 1H,1H,10H,10H-hexadecafluoro-1,10-decanediol, hexafluoro-2,3-bis(trifluoromethyl)-2,3-butanediol, 2,2,3,3,4,4,5,5-octafluoro-1,6-hexanediol, 2,2,3,3-tetrafluoro-1,4-butanediol, and 2,3,5,6-tetrafluoro-1,4-benzenedimethanol.

When the ink of the present disclosure includes the monomer G, the content of the monomer G relative to the total amount of the ink is preferably 0.1 mass % to 10 mass %, more preferably 0.3 mass % to 5 mass %, still more preferably 0.5 mass % to 3 mass %.

When the ink of the present disclosure contains the monomer G, the ratio of the mass content of the monomer G to the total mass content of all polymerizable monomers contained in the ink (hereinafter also referred to as the “monomer G/all monomers ratio”) is preferably 0.01 to 0.2, more preferably 0.02 to 0.1.

The preferred range of the ratio of the mass content of the monomer G to the total mass content of all radical-polymerizable monomers contained in the ink is the same as the preferred range of the monomer G/all monomers ratio described above.

When the ink of the present disclosure contains at least one selected from the group consisting of the monomer E, the monomer F, and the monomer G, the total content of the monomer E, the monomer F, and the monomer G relative to the total amount of the ink is preferably 0.1 mass % to 10 mass %, more preferably 0.3 mass % to 5 mass %, still more preferably 0.5 mass % to 3 mass %.

When the ink of the present disclosure contains at least one selected from the group consisting of the monomer E, the monomer F, and the monomer G, the ratio of the total mass content of the monomer E, the monomer F, and the monomer G relative to the total mass content of all polymerizable monomers contained in the ink (hereinafter also referred to as the “(monomer E+monomer F+monomer G)/all monomers ratio”) is preferably 0.01 to 0.2, more preferably 0.02 to 0.1.

The preferred range of the ratio of the total mass content of the monomer E, the monomer F, and the monomer G to the total mass content of all radical-polymerizable monomers contained in the ink is the same as the preferred range of the (monomer E+monomer F+monomer G)/all monomers ratio described above.

### Compound H

The ink of the present disclosure preferably contains a compound H that is at least one selected from the group consisting of organic solvents, alkyl (meth)acrylates having an alkyl group of 1 to 4 carbon atoms, and styrene optionally having a substituent other than a fluorine atom.

When the ink of the present disclosure contains the compound H, the adhesiveness over time of an image is further improved.

While the reason why this effect is produced is not clear, it is presumed that when the ink is applied to a polyvinyl chloride building material, the compound H in the ink dissolves or swells the polyvinyl chloride building material, whereby the adhesiveness (adhesiveness before the passage of time) between an image formed by the ink and the polyvinyl chloride building material is improved, and the adhesiveness before the passage of time will be maintained if the image is subjected to the passage of time in an outdoor environment.

When the ink of the present disclosure contains the compound H, the adhesiveness over time of an image as well as the adhesiveness over time of an image may be further improved.

### Organic Solvent Serving as Compound H

Examples of organic solvents that serve as the compound H include, but are not limited to, ketone compounds, ester compounds, alcohol compounds, ether compounds, hydrocarbon compounds, aromatic compounds, and cellosolve compounds.

Examples of ketone compounds include aliphatic ketones and aromatic ketones.

Examples of aliphatic ketones include acetone, cyclohexanone, diisopropyl ketone, methyl ethyl ketone, and diethyl ketone.

Examples of aromatic ketones include acetophenone.

Examples of ester compounds include acetates, acetoacetates, and aromatic carboxylates. The ester compounds are distinguished from the above ketone compounds by not having a ketone group in their molecules.

Examples of acetates include methyl acetate, ethyl acetate, isopropyl acetate, propyl acetate, butyl acetate, pentyl acetate, cellosolve acetate, and 3-methoxybutyl acetate.

Examples of acetoacetates include ethyl acetoacetate.

Examples of aromatic carboxylates include dibutyl phthalate.

Examples of alcohol compounds include alcohol compounds having an alicyclic structure. The alcohol compounds are distinguished from the above ketone compounds and ester compounds by not having a ketone group or an ester group in their molecules.

Examples of alcohol compounds having an alicyclic structure include cyclohexanol.

Examples of ether compounds include cyclic ether compounds and cellosolve compounds. The ether compounds are distinguished from the above ketone compounds, ester compounds, and alcohol compounds by not containing a ketone group, an ester group, or an alcoholic hydroxyl group in their molecules.

Examples of cyclic ether compounds include tetrahydrofuran, dioxane, and furan.

Examples of cellosolve compounds include butyl cellosolve and ethyl cellosolve.

The hydrocarbon compounds may be aliphatic hydrocarbon compounds or aromatic hydrocarbon compounds. The hydrocarbon compounds are distinguished from the above ketone compounds, ester compounds, alcohol compounds, and ether compounds by not having a ketone group, an ester group, an alcoholic hydroxyl group, or an ether bond in their molecules.

Examples of aliphatic hydrocarbon compounds include cyclohexane and pinene.

Examples of aromatic hydrocarbon compounds include ethylbenzene, toluene, and xylene.

Examples of alkyl (meth)acrylates having an alkyl group of 1 to 4 carbon atoms, the alkyl (meth)acrylates serving as the compound H, include methyl (meth)acrylate, ethyl (meth)acrylate, propyl (meth)acrylate, isopropyl (meth)acrylate, butyl (meth)acrylate, and isobutyl (meth)acrylate.

Examples of styrene optionally having a substituent other than a fluorine atom, the styrene serving as the compound H, include styrene and methylstyrene.

When the ink of the present disclosure contains the compound H, the content of the compound H relative to the total amount of the ink is preferably 0.01 mass % to 30 mass %, more preferably 0.05 mass % to 25 mass %, still more preferably 0.05 mass % to 20 mass %.

When the ink of the present disclosure contains the compound H, the content of the compound H relative to the total content of all polymerizable monomers contained in the ink is preferably 0.01 mass % or more and 50 mass % or less, more preferably 0.05 mass % to 40 mass %, still more preferably 0.05 mass % to 35 mass %, even more preferably 0.05 mass % to 25 mass %, particularly preferably 0.05 mass % to 20 mass %.

When the content of the compound H is 0.01 mass % or more relative to the total content of all polymerizable monomers contained in the ink, the adhesiveness over time of an image is further improved.

When the content of the compound H is 50 mass % or less relative to the total content of all polymerizable monomers, the rubfastness over time of an image is further improved.

The preferred range of the content of the compound H relative to the total content of all radical-polymerizable monomers contained in the ink is also the same as that of the content of the compound H relative to the total content of all polymerizable monomers contained in the ink described above.

### Other Polymerizable Monomer

The ink of the present disclosure may contain another polymerizable monomer other than the monomers described above.

The other polymerizable monomer is preferably a radical-polymerizable monomer, more preferably an ethylenically unsaturated compound.

The radical-polymerizable monomer serving as the other polymerizable monomer (hereinafter also referred to as the “other radical-polymerizable monomer”) may be a known radical-polymerizable monomer, and examples include (meth)acrylate compounds, (meth)acrylamide compounds, vinyl ether compounds, allyl compounds, N-vinyl compounds, and unsaturated carboxylic acids.

The other polymerizable monomer may be, for example, a radical-polymerizable monomer described in JP2009-221414A, a radical-polymerizable compound described in JP2009-209289A, or an ethylenically unsaturated compound described in JP2009-191183A.

The other radical-polymerizable monomer is preferably a (meth)acrylate compound, more preferably an acrylate compound.

The other radical-polymerizable monomer may be a monofunctional radical-polymerizable monomer or a bi- or higher functional radical-polymerizable monomer.

The ink of the present disclosure preferably contains, as the other radical-polymerizable monomer, a bi- or higher functional radical-polymerizable monomer, more preferably contains a bifunctional or trifunctional radical-polymerizable monomer, still more preferably contains a bifunctional radical-polymerizable monomer.

Specific examples of the other radical-polymerizable monomer include:

monofunctional (meth)acrylate compounds such as alkyl (meth)acrylate compounds having an alkyl group of five or more carbon atoms;

bifunctional (meth)acrylate compounds such as 1,6-hexanediol di(meth)acrylate, dipropylene glycol di(meth)acrylate, and propylene oxide (PO) modified neopentyl glycol di(meth)acrylate; and

trifunctional (meth)acrylate compounds such as tris(2-hydroxyethyl) isocyanurate tri(meth)acrylate and ethylene oxide (EO) modified trimethylolpropane tri(meth)acrylate.

Examples of the other radical-polymerizable monomer also include unsaturated carboxylic acids such as acrylic acid, methacrylic acid, itaconic acid, crotonic acid, isocrotonic acid, and maleic acid and salts thereof, anhydrides having an ethylenically unsaturated group, acrylonitrile, styrene, and various unsaturated polyesters, unsaturated polyethers, unsaturated polyamides, and unsaturated urethanes.

More specifically, commercially available products described in, for example, “Crosslinking Agent Handbook” (1981, Taiseisha Ltd.) edited by Shinzo Yamashita; “UV/EB Curing Handbook (Raw Material)” (1985, Kobunshi Kankokai) edited by Kiyoshi Kato; “Application and Market of UV/EB Curing Technology” p. 79 (1989, CMC Publishing Co., Ltd.) edited by RadTech Japan; and “Polyester Resin Handbook” (1988, Nikkan Kogyo Shimbun, Ltd.) written by Eiichiro Takiyama, and radical-polymerizable monomers, oligomers, and polymers known in the art can be used.

The molecular weight of the other radical-polymerizable monomer is preferably 80 to 1,000, more preferably 80 to 800, still more preferably 80 to 500.

In the ink of the present disclosure, the total content of the polymerizable monomers relative to the total amount of the ink is preferably 50 mass % or more, more preferably 55 mass % or more, still more preferably 60 mass % or more.

The upper limit of the total content of the polymerizable monomers is not particularly limited and may be, for example, 95 mass % or 90 mass %.

Examples of the preferred range and upper limit of the total content of the radical-polymerizable monomers in the ink of the present disclosure are the same as the above-described examples of the preferred range and upper limit of the total content of the polymerizable monomers in the ink of the present disclosure.

In the ink of the present disclosure, the total content of the monofunctional radical-polymerizable monomers and the bifunctional radical-polymerizable monomers relative to the total amount of the ink is preferably 50 mass % or more, more preferably 55 mass % or more, still more preferably 60 mass % or more.

The upper limit of the total content of the monofunctional radical-polymerizable monomers and the bifunctional radical-polymerizable monomers is not particularly limited and may be, for example, 95 mass % or 90 mass %.

In the ink of the present disclosure, the proportion of the monofunctional radical-polymerizable monomers in all radical-polymerizable monomers is preferably 60 mass % or more, more preferably 65 mass % or more, still more preferably 70 mass % or more.

The upper limit of the proportion of the monofunctional radical-polymerizable monomers in all radical-polymerizable monomers is not particularly limited, and the upper limit may be, for example, 100 mass %, 95 mass %, or 90 mass %.

### Photopolymerization Initiator

The ink of the present disclosure preferably contains a photopolymerization initiator.

When the ink of the present disclosure contains a photopolymerization initiator, one or more photopolymerization initiators may be contained.

The photopolymerization initiator may be a known photopolymerization initiator that absorbs light (i.e., active radiation) to generate radicals serving as polymerization initiation species.

Examples of preferred photopolymerization initiators include (a) carbonyl compounds such as aromatic ketones, (b) acylphosphine oxide compounds, (c) aromatic onium salt compounds, (d) organic peroxides, (e) thio compounds, (f) hexaarylbiimidazole compounds, (g) ketoxime ester compounds, (h) borate compounds, (i) azinium compounds, (j) metallocene compounds, (k) active ester compounds, (l) compounds having a carbon-halogen bond, and (m) alkylamine compounds.

As the photopolymerization initiator, the above compounds (a) to (m) may be used alone or in combination of two or more.

More preferred photopolymerization initiators are (a), (b), and (e) above.

Preferred examples of (a) carbonyl compounds, (b) acylphosphine oxide compounds, and (e) thio compounds include compounds having a benzophenone skeleton or a thioxanthone skeleton, as described in “RADIATION CURING IN POLYMER SCIENCE AND TECHNOLOGY”, J. P. FOUASSIER, J. F. RABEK (1993), pp. 77 to 117.

More preferred examples include α-thiobenzophenone compounds described in JP1972-6416B (JP-S47-6416B), benzoin ether compounds described in JP1972-3981B (JP-S47-3981B), a-substituted benzoin compounds described in JP1972-22326B (JP-S47-22326B), benzoin derivatives described in JP1972-23664B (JP-547-23664B), aroyl phosphonates described in JP1982-30704A (JP-S57-30704A), dialkoxybenzophenones described in JP1985-26483B (JP-560-26483B), benzoin ethers described in JP1985-26403B (JP-560-26403B) and JP1987-81345A (JP-562-81345A), α-aminobenzophenones described in JP1989-34242B (JP-H1-34242B), U54318791A, and EP0284561A1, p-di(dimethylaminobenzoyl)benzene described in JP1990-211452A (JP-H2-211452A), thio-substituted aromatic ketones described in JP1986-194062A (JP-561-194062A), acylphosphine sulfides described in JP1990-9597B (JP-H2-9597B), acylphosphines described in JP1990-9596B (JP-H2-9596B), thioxanthones described in JP1988-61950B (JP-563-61950B), and coumarins described in JP1984-42864B (JP-559-42864B).

Polymerization initiators described in in JP2008-105379A and JP2009-114290A are also preferred.

Of these photopolymerization initiators, (a) carbonyl compounds or (b) acylphosphine oxide compounds are more preferred. Specific examples include bis(2,4,6-trimethylbenzoyl)-phenylphosphine oxide (e.g., IRGACURE (registered trademark) 819 manufactured by BASF), 2-(dimethylamine)-1-(4-morpholinophenyl)-2-benzyl-1-butanone (e.g., IRGACURE (registered trademark) 369 manufactured by BASF), 2-methyl-1-(4-methylthiophenyl)-2-morpholinopropan-1-one (e.g., IRGACURE (registered trademark) 907 manufactured by BASF), 1-hydroxy-cyclohexyl-phenyl-ketone (e.g., IRGACURE (registered trademark) 184 manufactured by BASF), and 2,4,6-trimethylbenzoyl-diphenyl-phosphine oxide (e.g., DAROCUR (registered trademark) TPO and LUCIRIN (registered trademark) TPO (both manufactured by BASF)).

Of these, from the viewpoint of, for example, improvement of sensitivity and suitability for LED light, the photopolymerization initiator is preferably (b) an acylphosphine oxide compound, more preferably a monoacylphosphine oxide compound (particularly preferably, 2,4,6-trimethylbenzoyl-diphenyl-phosphine oxide) or a bisacylphosphine oxide compound (particularly preferably, bis(2,4,6-trimethylbenzoyl)-phenylphosphine oxide).

When the ink of the present disclosure contains a photopolymerization initiator, the content of the photopolymerization initiator relative to the total amount of the ink is preferably 1.0 mass % to 25.0 mass %, more preferably 2.0 mass % to 20.0 mass %, still more preferably 3.0 mass % to 15.0 mass %.

### Sensitizer

The ink of the present disclosure preferably contains a sensitizer.

When the ink of the present disclosure contains a sensitizer, one or more sensitizers may be contained.

Here, the sensitizer is a substance that absorbs a specific active radiation to enter an electronically excited state. The sensitizer in the electronically excited state comes in contact with the photopolymerization initiator to cause an action such as electron transfer, energy transfer, or heat generation. This promotes a chemical change of the photopolymerization initiator, specifically, for example, decomposition, or generation of radicals, acids, or bases.

Examples of the sensitizer include ethyl 4-(dimethylamino) benzoate (EDB), anthraquinone, 3-acylcoumarin derivatives, terphenyl, styryl ketone, 3-(aroylmethylene)thiazoline, camphorquinone, eosin, rhodamine, and erythrosine.

As the sensitizer, a compound represented by general formula (i) described in JP2010-24276A and a compound represented by general formula (I) described in JP1994-107718A (JP-H6-107718A) are also suitable for use.

Among the above, the sensitizer is preferably at least one selected from thioxanthone, isopropylthioxanthone, ethyl 4-(dimethylamino) benzoate, and benzophenone, from the viewpoint of suitability for LED light and reactivity with photopolymerization initiators.

When the ink of the present disclosure contains a sensitizer, the content of the sensitizer is preferably 0.5 mass % to 10 mass %, more preferably 1.0 mass % to 7.0 mass %, particularly preferably 2.0 mass % to 6.0 mass %.

### Surfactant

The ink of the present disclosure may contain a surfactant.

Examples of the surfactant include surfactants described in JP1987-173463A (JP-S62-173463A) and JP1987-183457A (JP-S62-183457A). Examples include anionic surfactants such as dialkyl sulfosuccinates, alkylnaphthalene sulfonates, and fatty acid salts; nonionic surfactants such as polyoxyethylene alkyl ethers, polyoxyethylene alkyl allyl ethers, acetylene glycol, polyoxyethylene-polyoxypropylene block copolymers, and silicones such as modified polydimethylsiloxane; cationic surfactants such as alkylamine salts and quarternary ammonium salts; and betaine surfactants such as carbobetaine and sulfobetaine.

An organofluorine compound having no polymerizable groups may be used instead of the surfactant. The organofluorine compound is preferably hydrophobic. The organofluorine compound includes, for example, fluorine-containing surfactants, oily fluorine-containing compounds (e.g., fluorine oil), and solid fluorine compound resins (e.g., tetrafluoroethylene resins), and examples include compounds described in JP1982-9053B (JP-S57-9053B) (the 8th to 17th columns) and JP1987-135826A (JP-S62-135826A).

When the ink of the present disclosure contains a surfactant, the content of the surfactant relative to the total amount of the ink is preferably 0.01 mass % to 5.0 mass %, more preferably 0.1 mass % to 3.0 mass %, particularly preferably 0.3 mass % to 2.0 mass %.

### Polymerization Inhibitor

The ink of the present disclosure may contain a polymerization inhibitor.

Examples of the polymerization inhibitor include p-methoxyphenol, quinones (e.g., hydroquinone, benzoquinone, and methoxybenzoquinone), phenothiazine, catechols, alkylphenols (e.g., dibutylhydroxytoluene (BHT)), alkyl bisphenols, zinc dimethyldithiocarbamate, copper dimethyldithiocarbamate, copper dibutyldithiocarbamate, copper salicylate, thiodipropionates, mercaptobenzimidazole, phosphites, 2,2,6,6-tetramethylpiperidine-1-oxyl (TEMPO), 2,2,6,6-tetramethyl-4-hydroxypiperidine-1-oxyl (TEMPOL), and tris(N-nitroso-N-phenylhydroxylamine)aluminum salt (also known as cupferron Al).

Of these, at least one selected from the group consisting of p-methoxyphenol, catechols, quinones, alkylphenols, TEMPO, TEMPOL, and tris(N-nitroso-N-phenylhydroxylamine) aluminum salt is preferred, and at least one selected from the group consisting of p-methoxyphenol, hydroquinone, benzoquinone, BHT, TEMPO, TEMPOL, and tris(N-nitroso-N-phenylhydroxylamine)aluminum salt is more preferred.

When the ink of the present disclosure contains a polymerization inhibitor, the content of the polymerization inhibitor relative to the total amount of the ink is preferably 0.01 mass % to 2.0 mass %, more preferably 0.02 mass % to 1.0 mass %, particularly preferably 0.03 mass % to 0.5 mass %.

### Resin

The ink of the present disclosure may contain at least one resin.

The resin is preferably a resin having no polymerizable groups.

Examples of the resin include epoxy resins, vinyl chloride resins, vinyl acetate resins, polyesters, (meth)acrylic resins, chlorinated polyolefins, and polyketones.

Examples of commercially available vinyl chloride resins include UCAR solution vinyl resins VYHD, VYHH, VMCA, VROH, and VYLF-X manufactured by The Dow Chemical Company; SOLBIN resins CL, CNL, C5R, and TA5R manufactured by Nissin Chemical Co., Ltd.; and VINNOL (registered trademark) E15/40, E15/45, H14/36, H15/42, H15/50, H11/59, H40/43, H40/50, H40/55, H40/60, H15/45M, E15/45M, and E15/40A manufactured by Wacker.

Examples of (meth)acrylic resins include copolymers of methyl methacrylate and n-butyl methacrylate.

Examples of commercially available (meth)acrylic resins include Elvacite 2013 (copolymer of methyl methacrylate and n-butyl methacrylate, Mw=34,000), Elvacite 2014 (copolymer of methyl methacrylate and n-butyl methacrylate, Mw=119,000), and Elvacite 4099 (copolymer of methyl methacrylate and n-butyl methacrylate, Mw=15,000) manufactured by Lucite International; and DIANAL (registered trademark) BR-113 (butyl methacrylate resin, Mw=30,000) manufactured by Mitsubishi Chemical Corporation.

Examples of commercially available polyesters include polyester resins (“TEGO (registered trademark) AddBond LTH”; Mw=3,000) manufactured by Evonik Japan Co., Ltd.

Examples of commercially available chlorinated polyolefins include SUPERCHLON (registered trademark) 814HS manufactured by Nippon Paper Industries Co., Ltd.

Examples of commercially available polyketones include TEGO (registered trademark) VARIPLUS AP, CA, and SK manufactured by Evonik.

The weight-average molecular weight (Mw) of the resin is preferably 3,000 to 200,000, more preferably 5,000 to 200,000, still more preferably 10,000 to 150,000, even more preferably 10,000 to 100,000, particularly preferably 10,000 to 50,000.

When the ink includes a resin, the content of the resin relative to the total amount of the ink is preferably 1 mass % to 10 mass %, more preferably 1.5 mass % to 10 mass %, particularly preferably 2 mass % to 6 mass %.

### Water

The ink of the present disclosure may contain a small amount of water.

Specifically, the content of water relative to the total amount of the ink of the present disclosure is preferably 3 mass % or less, more preferably 2 mass % or less, particularly preferably 1 mass % or less.

The ink of the present disclosure is preferably a non-aqueous ink containing substantially no water.

### Other Components

The ink of the present disclosure may contain other components other than the above.

Examples of the other components include UV absorbers, co-sensitizers, antioxidants, anti-fading agents, and electroconductive salts.

Regarding the other components, reference can be made, as appropriate, to known publications such as JP2011-225848A and JP2009-209352A.

### Preferred Physical Properties of Ink

The viscosity of the ink of the present disclosure is not particularly limited.

The viscosity at 25° C. of the ink of the present disclosure is preferably 10 mPa·s to 50 mPa·s, more preferably 10 mPa·s to 30 mPa·s, still more preferably 10 mPa·s to 25 mPa·s. The viscosity of the ink can be adjusted, for example, by adjusting the composition ratio of contained components.

Herein, the viscosity is a value measured using a viscometer: VISCOMETER RE-85L (manufactured by Toki Sangyo Co., Ltd.).

When the viscosity of the ink is within the above preferred range, ejection stability can be further improved.

The surface tension of the ink of the present disclosure is not particularly limited.

The surface tension at 30° C. of the ink of the present disclosure is preferably 20 mN/m to 30 mN/m, more preferably 23 mN/m to 28 mN/m. In terms of wettability, the surface tension is preferably 30 mN/m or less, and in terms of permeability and prevention of bleeding, the surface tension is preferably 20 mN/m or more.

Herein, the surface tension is a value measured using a DY-700 surface tensiometer (manufactured by Kyowa Interface Science Co., Ltd.).

### Image Recording Method

An image recording method of the present disclosure has a step of applying the ink of the present disclosure to a polyvinyl chloride building material by an ink jet method (hereinafter also referred to as an “application step”) and a step of irradiating the ink applied to the polyvinyl chloride building material with an active radiation (i.e., “light” in the present specification) (hereinafter also referred to as an “irradiation step”).

According to the image recording method of the present disclosure, an image having high coating adhesiveness, high rubfastness, and high curability can be recorded.

### Polyvinyl Chloride Building Material

In the image recording method of the present disclosure, a polyvinyl chloride building material is used.

From the viewpoint of use as a building material, the polyvinyl chloride building material is preferably a rigid polyvinyl chloride building material.

Here, the rigid polyvinyl chloride building material means a polyvinyl chloride building material having a polyvinyl chloride content of 70 mass % or more relative to the total amount of the building material.

The rigid polyvinyl chloride building material is preferably a rigid polyvinyl chloride building material containing no plasticizers (e.g., bis 2-ethylhexyl phthalate) or having a plasticizer content, if contained, of less than 10 mass % (more preferably less than 5 mass %) relative to the total amount of the building material.

One example of the polyvinyl chloride building material is a siding material.

In this case, recording an image on the siding material by the image recording method of the present disclosure can improve the design of the siding material. Moreover, the recorded image has high adhesiveness over time and high rubfastness over time as described above.

### Application Step

The application step is a step of applying the ink of the present disclosure to a polyvinyl chloride building material (hereinafter also referred to simply as a “building material”) by an ink jet method.

The application of the ink by an ink jet method can be performed using a known ink jet recording apparatus.

The ink jet recording apparatus is not particularly limited, and a known ink jet recording apparatus that can achieve a desired resolution can be freely selected and used. That is, known ink jet recording apparatuses including commercially available products can be used.

The ink jet recording apparatus may be, for example, an apparatus including an ink supply system, a temperature sensor, and heating means.

The ink supply system is constituted by, for example, a source tank including an ink, a supply pipe, an ink supply tank disposed immediately upstream of an ink jet head, a filter, and a piezoelectric ink jet head. The piezoelectric ink jet head can be driven so as to eject multi-size dots of preferably 1 pL to 100 pL, more preferably 8 pL to 30 pL, at a resolution of preferably 320 dpi (dot per inch)×320 dpi to 4000 dpi×4000 dpi (dot per inch), more preferably 400 dpi×400 dpi to 1600 dpi×1600 dpi, still more preferably 720 dpi×720 dpi to 1600 dpi×1600 dpi.

The term “dpi” represents the number of dots per 2.54 cm (1 inch).

### Irradiation Step

The irradiation step is a step of irradiating the ink applied to the building material with an active radiation.

By irradiating the ink applied to the building material with an active radiation, the polymerization reaction of polymerizable monomers in the ink is allowed to proceed. This can fix an image and improve, for example, the hardness of the image.

Examples of active radiations that can be used in the irradiation step include ultraviolet radiation (UV light), visible radiation, and electron beams. Of these, UV light is preferred.

The peak wavelength of the active radiation is preferably 200 nm to 405 nm, more preferably 220 nm to 390 nm, still more preferably 220 nm to 385 nm.

A peak wavelength of 200 nm to 310 nm is also preferred, and a peak wavelength of 200 nm to 280 nm is also preferred.

The exposure energy during the irradiation with an active radiation is, for example, 10 mJ/cm² to 2000 mJ/cm², preferably 20 mJ/cm² to 1000 mJ/cm².

As sources for generating active radiations, mercury lamps, metal halide lamps, UV fluorescent lamps, gas lasers, solid-state lasers, and the like are widely known.

Replacement of these light sources listed as examples with semiconductor ultraviolet emission devices is very beneficial from industrial and environmental standpoints.

Among the semiconductor ultraviolet emission devices, LEDs (light emitting diodes) and LDs (laser diodes), which have small sizes and long operating lives and are highly efficient and inexpensive, hold promise as light sources.

Preferred light sources are metal halide lamps, extra-high-pressure mercury lamps, high-pressure mercury lamps, medium-pressure mercury lamps, low-pressure mercury lamps, LEDs, and blue-violet lasers.

Of these, in the case where a sensitizer and a photopolymerization initiator are used in combination, an extra-high-pressure mercury lamp capable of applying light having a wavelength of 365 nm, 405 nm, or 436 nm, a high-pressure mercury lamp capable of applying light having a wavelength of 365 nm, 405 nm, or 436 nm, or an LED capable of applying light having a wavelength of 355 nm, 365 nm, 385 nm, 395 nm, or 405 nm is more preferred, and an LED capable of applying light having a wavelength of 355 nm, 365 nm, 385 nm, 395 nm, or 405 nm is most preferred.

In the irradiation step, the time during which the ink applied to the building material is irradiated with an active radiation is, for example, 0.01 seconds to 120 seconds, preferably 0.1 seconds to 90 seconds.

Regarding irradiation conditions and a basic irradiation method, the irradiation conditions and irradiation method disclosed in JP1982-132767A (JP-S60-132767A) can be applied in a similar manner.

Specifically, the irradiation with an active radiation is preferably performed by a method in which light sources are disposed on both sides of a head unit including an ink ejection device, and the head unit and the light sources are scanned in what is called a shuttle mode; or a method in which the irradiation with an active radiation is performed using another light source that is not driven.

The irradiation with an active radiation is preferably performed after a certain period of time (e.g., 0.01 seconds to 120 seconds, preferably 0.01 seconds to 60 seconds) from landing and heat-drying of the ink.

### Heat Drying Step

The image recording method may optionally further has a heat drying step after the application step and before the irradiation step.

Examples of heating means include, but are not limited to, heat drums, hot air, infrared lamps, hot ovens, and heating plates.

The heating temperature is preferably 40° C. or higher, more preferably about 40° C. to 150° C., still more preferably about 40° C. to 80° C.

The heating time can be appropriately set taking into account the composition of the ink and the printing speed.

### Image Recorded Article

An image recorded article of the present disclosure includes a polyvinyl chloride building material and an image disposed on the polyvinyl chloride building material, the image being a cured product of the ink of the present disclosure.

Therefore, the image recorded article of the present disclosure is excellent in adhesiveness over time between the polyvinyl chloride building material and the image and rubfastness over time of the image.

One example of the image recorded article of the present disclosure is a siding material with an image.

In the image recorded article of the present disclosure, the image that is a cured product of the ink of the present disclosure contains a polymer including a structural unit derived from a monomer A and the specific inorganic pigment described above.

Here, the structural unit derived from a monomer A means a structural unit formed by polymerization of the monomer A.

Regarding a preferred content of the structural unit derived from a monomer A in the polymer, reference can be made, as appropriate, to the monomer A/all monomers ratio in the section of the ink described above.

The polymer may contain another structural unit other than the structural unit derived from a monomer A.

The image that is a cured product of the ink of the present disclosure may include other components other than the specific inorganic pigment and the polymer.

Regarding the other structural unit and the other components, reference can be made, as appropriate, to the section of the ink described above.

### EXAMPLES

Examples of the present disclosure will now be described, but the present disclosure is not limited to the following Examples.

### Preparation of Cyan Mill Base

Raw materials in the following composition were mixed together and stirred using a mixer (L4R manufactured by Silverson) at 2,500 revolutions/min for 10 minutes to obtain a mixture. The mixture obtained was then placed in a DISPERMAT LS bead mill disperser (manufactured by VMA GETZMANN GMBH) and dispersed using YTZ balls (manufactured by Nikkato Corporation) having a diameter of 0.65 mm at 2,500 revolutions/min for 6 hours to prepare, as an inorganic pigment dispersion, a cyan mill base having the following composition.

### Composition of Cyan Mill Base

Sicopal Blue K6310: 40 parts by mass

(Cyan pigment (specific inorganic pigment); C.I. pigment blue 28, manufactured by BASF)

SOLSPERSE 32000: 10 parts by mass

(High molecular weight dispersant, manufactured by The Lubrizol Corporation)

SR339A: 49 parts by mass

(Monomer B; 2-phenoxyethyl acrylate (PEA), manufactured by Sartomer Japan, Inc.)

FLORSTAB UV12: 1.0 part by mass

(Polymerization inhibitor; cupferron Al, manufactured by Kromachem)

### Preparation of Magenta Mill Base

A magenta mill base having the following composition was prepared in the same manner as the cyan mill base except that some of the raw materials were changed.

### Composition of Magenta Mill Base

Sicotrans Red L2818: 30 parts by mass

(Magenta pigment (specific inorganic pigment); C.I. pigment red 101, manufactured by BASF)

SOLSPERSE 32000: 10 parts by mass

SR339A: 59 parts by mass

FLORSTAB UV12: 1.0 part by mass

### Preparation of Yellow Mill Base 1

A yellow mill base 1 having the following composition was prepared in the same manner as the cyan mill base except that some of the raw materials were changed.

### Composition of Yellow Mill Base 1

Sicotrans Gelb L1915: 30 parts by mass

(Yellow pigment (specific inorganic pigment); C.I. pigment yellow 42, manufactured by BASF)

SOLSPERSE 32000: 10 parts by mass

SR339A: 59 parts by mass

FLORSTAB UV12: 1.0 part by mass

### Preparation of Yellow Mill Base 2

A yellow mill base 2 having the following composition was prepared in the same manner as the cyan mill base except that some of the raw materials were changed.

### Composition of Yellow Mill Base 2

Lysopac Yellow 6615B: 40 parts by mass

(Yellow pigment (specific inorganic pigment); C.I. pigment yellow 184, manufactured by Cappelle Pigments NVF)

SOLSPERSE 32000: 10 parts by mass

SR339A: 49 parts by mass

FLORSTAB UV12: 1.0 part by mass

### Preparation of White Mill Base

A white mill base having the following composition was prepared in the same manner as the cyan mill base except that some of the raw materials were changed.

### Composition of White Mill Base

KRONOS2300: 40 parts by mass

(White pigment (specific inorganic pigment); C.I. pigment white 6, manufactured by KRONOS)

SOLSPERSE 32000: 10 parts by mass

SR339A: 49 parts by mass

FLORSTAB UV12: 1.0 part by mass

### Preparation of Black Mill Base

A black mill base having the following composition was prepared in the same manner as the cyan mill base except that some of the raw materials were changed.

### Composition of Black Mill Base

SPECIAL BLACK 250: 40 parts by mass

(Black pigment (specific inorganic pigment); C.I. pigment black 7, manufactured by BASF)

SOLSPERSE 32000: 10 parts by mass

SR339A: 49 parts by mass

FLORSTAB UV12: 1.0 part by mass

### Example 1

### Preparation of Ink

Components in the following composition were mixed together to prepare an ink.

### Composition of Ink

The above cyan mill base: 25.0 parts by mass

Diethylaminoethyl methacrylate (hereinafter also referred to as “DEAEMA”) (monomer A): 56.0 parts by mass

SPEEDCURE BP: 1.2 parts by mass

(Photopolymerization initiator, benzophenone, manufactured by Lambson)

Lucirin TPO: 5.2 parts by mass

(Photopolymerization initiator, 2,4,6-trimethylbenzoyldiphenylphosphine oxide, manufactured by BASF)

SPEEDCURE ITX: 1.4 parts by mass

(Photopolymerization initiator, isopropylthioxanthone, manufactured by Lambson)

SPEEDCURE EDB: 1.7 parts by mass

(Sensitizer, ethyl 4-(dimethylamino) benzoate, manufactured by Lambson)

FLORSTAB UV12: 0.1 parts by mass

(Polymerization inhibitor, manufactured by Kromachem)

Dianal BR-113: 1.4 parts by mass

(Acrylic resin, Tg=78° C., manufactured by Mitsubishi Rayon Co., Ltd.)

BYK-307: 0.2 parts by mass

(Silicone surfactant, manufactured by BYK-Chemie)

### Image Recording

The ink was applied to a polyvinyl chloride building material by an ink jet method, and the applied ink was irradiated with UV light to record an image, thereby obtaining an image recorded article.

The recording of the image was performed using a LuxelJet UV550GTW UV ink jet printer manufactured by FUJIFILM Corporation under the conditions of production mode and lamp 7.

As the polyvinyl chloride building material, “SUNLOID” KD (registered trademark) milky ivory SKDG1200 manufactured by Sumitomo Bakelite Co., Ltd. was used. This polyvinyl chloride building material is a rigid polyvinyl chloride building material including no plasticizers.

The recorded image was an A2-size solid image.

### Evaluations

Using the above image recorded article, ink curability, image color-difference weather resistance (ΔE), image adhesiveness over time, and image rubfastness over time were evaluated.

The results are shown in Table 1.

### Ink Curability

Whether the surface of the image of the image recorded article was sticky was checked. In addition, a sheet of coated paper (OK Topcoat Plus manufactured by Oji Paper Co., Ltd.) was superposed on the entire image of the image recorded article and left to stand for one day, after which whether transfer from the image recorded article to the sheet of coated paper occurred was checked.

On the basis of these results, ink curability was evaluated according to the following evaluation criteria.

In the following evaluation criteria, the rank indicating highest ink curability is “5”.

### Evaluation Criteria for Ink Curability

5: The surface of the image was not sticky, and there was no transfer of the image.

4: The surface of the image was slightly sticky, but there was no transfer of the image.

3: The image slightly transferred.

2: The image transferred.

1: The image transferred very much.

### Image Color-Difference Weather Resistance (ΔE)

On the image recorded article produced, an accelerated weathering test for 2000 hours was performed in accordance with ISO4892-2 using a Ci4000 Weather-Ometer manufactured by Atlas.

The image recorded article before the accelerated weathering test and the image recorded article after the accelerated weathering test were each measured for image CIELAB values (L*, a*, b*) by using a CM-2600d spectrocolorimeter manufactured by Konica Minolta Optics, Inc. under the following conditions: light source, D65; field of view, 2°; and SCE (specular component excluded). On the basis of the results obtained, the image color difference ΔE before and after the accelerated weathering test for 2000 hours was determined, and on the basis of the color difference ΔE obtained, the image color-difference weather resistance (ΔE) was evaluated.

When the color difference ΔE is about 3.0 or less in the above evaluation of image color-difference weather resistance (ΔE), the color change is not recognized by human eyes.

### Image Adhesiveness Over Time

The image of the image recorded article after the accelerated weathering test for 2000 hours was subjected to a cross-hatch test in accordance with ISO2409 (cross-cut method) and evaluated for image adhesiveness over time according to the following evaluation criteria.

In the following evaluation criteria, the rank indicating highest image adhesiveness over time is “AA”.

In this cross-hatch test, cutting was performed at 1-mm intervals to form a grid of 25 squares of side 1 mm.

In the following evaluation criteria, the percentage (%) of flaked squares is a value determined by the following formula. The total number of squares in the following formula is 25.

Percentage (%) of flaked squares=[(number of flaked squares)/(total number of squares)]×100

### Evaluation Criteria for Image Adhesiveness Over Time

AA: The percentage (%) of flaked squares was 0%.

A: The percentage (%) of flaked squares was more than 0% and 5% or less.

B: The percentage (%) of flaked squares was more than 5% and 15% or less.

C: The percentage (%) of flaked squares was more than 15% and 35% or less.

D: The percentage (%) of flaked squares was more than 35% and 65% or less.

E: The percentage (%) of flaked squares was more than 65%.

### Image Rubfastness Over Time

Using the image recorded article after the accelerated weathering test for 2000 hours, image rubfastness over time was evaluated as described below.

Two paperweights (1.5 cm wide×1.5 cm thick×12 cm long) each weighing 200 g were stacked in the thickness direction and fixed together, and a piece of canvas (12.5 cm×5.5 cm) was fixed so as to cover the bottom and sides of the lower paperweight.

The paperweights to which the piece of canvas was fixed were placed on the image of the image recorded article after the accelerated weathering test for 2000 hours with the piece of canvas facing downward. In this state, a rubbing operation in which the paperweights to which the piece of canvas was fixed were moved back and forth in the length direction of the paperweights by a length of 12 cm 100 times was performed. Hereinafter, this rubbing operation is referred to as the 100 rubbing operations.

During the 100 rubbing operations, color migration from the image recorded article to the piece of canvas was visually observed as appropriate, and image rubfastness over time was evaluated according to the following evaluation criteria. In the following evaluation criteria, the rank indicating highest rubfastness is “AA”.

### Evaluation Criteria for Rubfastness of Cured Film

AA: Color migration from the image to the piece of canvas was not visually observed at the completion of the 100 rubbing operations.

A: Color migration from the image to the rubbing paper was visually observed at the completion of the 100 rubbing operations, but color migration from the image to the rubbing paper was not visually observed at the completion of 50 rubbing operations.

B: Color migration from the image to the rubbing paper was visually observed at the completion of 50 rubbing operations, but color migration from the image to the rubbing paper was not visually observed at the completion of 30 rubbing operations.

C: Color migration from the image to the rubbing paper was visually observed at the completion of 30 rubbing operations, but color migration from the image to the rubbing paper was not visually observed at the completion of 15 rubbing operations.

D: Color migration from the image to the rubbing paper was visually observed at the completion of 15 rubbing operations, but color migration from the image to the rubbing paper was not visually observed at the completion of five rubbing operations.

E: Color migration from the image to the rubbing paper was visually observed at the completion of five rubbing operations.

### Example 2 to Example 38 and Comparative Example 1

The same operation as in Example 1 was performed except that the monomer A (DEAEMA: 56.0 parts by mass) in the composition of the ink was replaced with a combination of monomers and a compound H shown in Table 1 to Table 4.

Examples 1 to 4 and Comparative Example 1 are examples not containing a compound H, and Examples 5 to 38 are examples containing a compound H.

The results are shown in Table 1 to Table 4.

### Examples 39 to 43

The same operation as in Example 10 was performed except that the cyan mill base serving as an inorganic pigment dispersion was replaced with an inorganic pigment dispersion shown in Table 4.

The results are shown in Table 4.

TABLE 1

| | | Comparative | Example | | | | | | | | | | |
|---|---|---|---|---|---|---|---|---|---|---|---|---|---|
| | | Example 1 | 1 | 2 | 3 | 4 | 5 | 6 | 7 | 8 | 9 | 10 | 11 |
| Inorganic | Cyan mill base | 25.0 | 25.0 | 25.0 | 25.0 | 25.0 | 25.0 | 25.0 | 25.0 | 25.0 | 25.0 | 25.0 | 25.0 |
| pigment | Magenta mill base | | | | | | | | | | | | |
| dispersion | Yellow mill base 1 | | | | | | | | | | | | |
| | Yellow mill base 2 | | | | | | | | | | | | |
| | White mill base | | | | | | | | | | | | |
| | Black mill base | | | | | | | | | | | | |
| Monomer A | DMAEA | | | 2.0 | | | 2.0 | 2.0 | | 2.0 | 2.0 | 2.0 | 2.0 |
| | DEAEA | | | | 2.0 | | | | | | | | |
| | DEAEMA | | 56.0 | | | 2.0 | | | | | | | |
| | PAEA | | | | | | | | 2.0 | | | | |
| Monomer B | PEA | | | | | | | | | | 11.6 | 11.6 | 11.6 |
| | BnMA | | | | | | | | | | | | |
| Monomer C | NVC | | | | | | | | | 14.0 | 14.0 | 14.0 | 14.0 |
| Monomer D | CyHA | | | | | | | | | | | 7.2 | 7.2 |
| | CTFA | | | | | | | | | | | | |
| | IBOA | | | | | | | | | | | | |
| Monomer E | GlyA | | | | | | | | | | | | |
| | EPCHMA | | | | | | | | | | | | |
| Monomer F | EOMA | | | | | | | | | | | | |
| Monomer G | TFPA | | | | | | | | | | | | |
| Other monomer | LA | 15.0 | | 15.0 | 15.0 | 15.0 | 15.0 | 15.0 | 15.0 | 11.0 | 7.0 | 5.0 | 5.0 |
| | TDA | 17.0 | | 17.0 | 17.0 | 17.0 | 17.0 | 17.0 | 17.0 | 12.0 | 8.4 | 5.6 | 5.6 |
| | HDDA | 24.0 | | 22.0 | 22.0 | 22.0 | 22.0 | 22.0 | 22.0 | 17.0 | 13.0 | 11.0 | 11.0 |
| Compound H | 3-MBA | | | | | | 2.0 | | 2.0 | 2.0 | 2.0 | 2.0 | |
| | CyHex | | | | | | | 2.0 | | | | | |
| | MEK | | | | | | | | | | | | 2.0 |
| | AcOBu | | | | | | | | | | | | |
| | Ethyl acetoacetate | | | | | | | | | | | | |
| | Dibutyl phthalate | | | | | | | | | | | | |
| | CyHex-OH | | | | | | | | | | | | |
| | Dioxane | | | | | | | | | | | | |
| | Cyclohexane | | | | | | | | | | | | |
| | Styrene | | | | | | | | | | | | |
| | Butyl acrylate | | | | | | | | | | | | |

| | | | | | | | | | | | | |
|---|---|---|---|---|---|---|---|---|---|---|---|---|
| All monomers in ink (parts by mass) | 68.3 | 68.3 | 68.3 | 68.3 | 68.3 | 68.3 | 68.3 | 68.3 | 68.3 | 68.3 | 68.7 | 68.7 |
| Content (mass %) of compound H relative to all | 0.0 | 0.0 | 0.0 | 0.0 | 0.0 | 2.9 | 2.9 | 2.9 | 2.9 | 2.9 | 2.9 | 2.9 |
| monomers | | | | | | | | | | | | |
| Monomer A/all monomers ratio | 0.00 | 0.82 | 0.03 | 0.03 | 0.03 | 0.03 | 0.03 | 0.03 | 0.03 | 0.03 | 0.03 | 0.03 |
| Monomer A/(monomer B + monomer C) ratio | 0.00 | 4.57 | 0.16 | 0.16 | 0.16 | 0.16 | 0.16 | 0.16 | 0.08 | 0.05 | 0.05 | 0.05 |
| Curability | 3 | 3 | 3 | 3 | 3 | 3 | 3 | 2 | 4 | 5 | 5 | 5 |
| Color-difference weather resistance (ΔE) | 3 | 2.5 | 3 | 3 | 3 | 3 | 3 | 5 | 3 | 3 | 3 | 3 |
| Adhesiveness over time | E | C | C | C | C | B | B | B | A | A | A | A |
| Rubfastness over time | E | D | D | D | D | D | D | D | C | B | A | A |

TABLE 2

| | | Example | | | | | | | | | | | | |
|---|---|---|---|---|---|---|---|---|---|---|---|---|---|---|
| | | 12 | 13 | 14 | 15 | 16 | 17 | 18 | 19 | 20 | 21 | 22 | 23 | 24 |
| Inorganic | Cyan mill base | 25.0 | 25.0 | 25.0 | 25.0 | 25.0 | 25.0 | 25.0 | 25.0 | 25.0 | 25.0 | 25.0 | 25.0 | 25.0 |
| pigment | Magenta mill base | | | | | | | | | | | | | |
| dispersion | Yellow mill base 1 | | | | | | | | | | | | | |
| | Yellow mill base 2 | | | | | | | | | | | | | |
| | White mill base | | | | | | | | | | | | | |
| | Black mill base | | | | | | | | | | | | | |
| Monomer A | DMAEA | 2.0 | 2.0 | 2.0 | | | | | | 0.1 | 0.2 | 13.0 | 2.0 | 17.0 |
| | DEAEA | | | | | | | | | | | | | |
| | DEAEMA | | | | 2.0 | 2.0 | 2.0 | 2.0 | 2.0 | | | | | |
| | PAEA | | | | | | | | | | | | | |
| Monomer B | PEA | | | | 11.6 | 11.6 | 11.6 | 11.6 | 11.6 | 11.6 | 11.6 | 5.0 | 5.0 | 3.0 |
| | BnMA | 11.6 | 11.6 | 11.6 | | | | | | | | | | |
| Monomer C | NVC | 14.0 | 14.0 | 14.0 | 14.0 | 14.0 | 14.0 | 14.0 | 14.0 | 14.0 | 14.0 | 7.0 | 21.0 | 3.3 |
| Monomer D | CyHA | 7.2 | | | | | | | | 7.2 | 7.2 | 7.2 | 7.2 | 7.2 |
| | CTFA | | 7.2 | | | | | | | | | | | |
| | IBOA | | | 7.2 | 7.2 | 7.2 | 7.2 | 7.2 | 7.2 | | | | | |
| Monomer E | GlyA | | | | 1.0 | | | 1.0 | | | | | | |
| | EPCHMA | | | | | | | | 1.0 | | | | | |
| Monomer F | EOMA | | | | | 1.0 | | | | | | | | |
| Monomer G | TFPA | | | | | | 1.0 | 1.0 | 1.0 | | | | | |
| Other monomer | LA | 5.0 | 5.0 | 5.0 | 5.0 | 5.0 | 5.0 | 5.0 | 5.0 | 5.0 | 5.0 | 5.0 | 5.0 | 5.0 |
| | TDA | 5.6 | 5.6 | 5.6 | 5.6 | 5.6 | 5.6 | 5.6 | 5.6 | 5.6 | 5.6 | 5.6 | 5.6 | 5.6 |
| | HDDA | 11.0 | 11.0 | 11.0 | 11.0 | 11.0 | 11.0 | 11.0 | 11.0 | 11.0 | 11.0 | 11.0 | 11.0 | 11.0 |
| Compound H | 3-MBA | 2.0 | 2.0 | 2.0 | | | | | | 2.0 | 2.0 | 2.0 | 2.0 | 2.0 |
| | CyHex | | | | 2.0 | 2.0 | 2.0 | 2.0 | 2.0 | | | | | |
| | MEK | | | | | | | | | | | | | |
| | AcOBu | | | | | | | | | | | | | |
| | Ethyl acetoacetate | | | | | | | | | | | | | |
| | Dibutyl phthalate | | | | | | | | | | | | | |
| | CyHex-OH | | | | | | | | | | | | | |
| | Dioxane | | | | | | | | | | | | | |
| | Cyclohexane | | | | | | | | | | | | | |
| | Styrene | | | | | | | | | | | | | |
| | Butyl acrylate | | | | | | | | | | | | | |

| | | | | | | | | | | | | | |
|---|---|---|---|---|---|---|---|---|---|---|---|---|---|
| All monomers in ink (parts by mass) | 68.7 | 68.7 | 68.7 | 69.7 | 69.7 | 69.7 | 70.7 | 70.7 | 66.8 | 66.8 | 66.1 | 69.1 | 64.4 |
| Content (mass %) of compound H relative to | 2.9 | 2.9 | 2.9 | 2.9 | 2.9 | 2.9 | 2.8 | 2.8 | 3.0 | 3.0 | 3.0 | 2.9 | 3.1 |
| all monomers | | | | | | | | | | | | | |
| Monomer A/all monomers ratio | 0.03 | 0.03 | 0.03 | 0.03 | 0.03 | 0.03 | 0.03 | 0.03 | 0.001 | 0.002 | 0.20 | 0.03 | 0.26 |
| Monomer A/(monomer B + monomer C) | 0.05 | 0.05 | 0.05 | 0.05 | 0.05 | 0.05 | 0.05 | 0.05 | 0.003 | 0.004 | 0.536 | 0.052 | 0.916 |
| ratio | | | | | | | | | | | | | |
| Curability | 5 | 5 | 5 | 5 | 5 | 5 | 5 | 5 | 5 | 5 | 5 | 5 | 5 |
| Color-difference weather resistance (ΔE) | 3 | 3 | 3 | 3 | 3 | 2.5 | 2.5 | 2.5 | 3 | 3 | 3 | 3 | 3 |
| Adhesiveness over time | A | A | A | AA | AA | AA | AA | AA | B | A | A | A | A |
| Rubfastness over time | A | A | A | AA | AA | AA | AA | AA | B | A | A | A | B |

TABLE 3

| | | Example | | | | | | | | | | | |
|---|---|---|---|---|---|---|---|---|---|---|---|---|---|
| | | 25 | 26 | 27 | 28 | 29 | 30 | 31 | 32 | 33 | 34 | 35 | 36 |
| Inorganic | Cyan mill | 25.0 | 25.0 | 25.0 | 25.0 | 25.0 | 25.0 | 25.0 | 25.0 | 25.0 | 25.0 | 25.0 | 25.0 |
| pigment | base | | | | | | | | | | | | |
| dispersion | Magenta mill | | | | | | | | | | | | |
| | base | | | | | | | | | | | | |
| | Yellow mill | | | | | | | | | | | | |
| | base 1 | | | | | | | | | | | | |
| | Yellow mill | | | | | | | | | | | | |
| | base 2 | | | | | | | | | | | | |
| | White mill | | | | | | | | | | | | |
| | base | | | | | | | | | | | | |
| | Black mill | | | | | | | | | | | | |
| | base | | | | | | | | | | | | |
| Monomer A | DMAEA | 2.0 | 2.0 | 2.0 | 2.0 | 2.0 | 2.0 | 2.0 | 2.0 | 2.0 | 2.0 | 2.0 | 2.0 |
| | DEAEA | | | | | | | | | | | | |
| | DEAEMA | | | | | | | | | | | | |
| | PAEA | | | | | | | | | | | | |
| Monomer B | PEA | 21.0 | 11.6 | 11.6 | 11.6 | 11.6 | 11.6 | 11.6 | 11.6 | 11.6 | 11.6 | 11.6 | 11.6 |
| | BnMA | | | | | | | | | | | | |
| Monomer C | NVC | 5.0 | 14.0 | 14.0 | 14.0 | 14.0 | 14.0 | 14.0 | 14.0 | 14.0 | 14.0 | 14.0 | 14.0 |
| Monomer D | CyHA | 7.2 | 7.2 | 7.2 | 7.2 | 7.2 | 7.2 | 7.2 | 7.2 | 7.2 | 7.2 | 7.2 | 7.2 |
| | CTFA | | | | | | | | | | | | |
| | IBOA | | | | | | | | | | | | |
| Monomer E | GlyA | | | | | | | | | | | | |
| | EPCHMA | | | | | | | | | | | | |
| Monomer F | EOMA | | | | | | | | | | | | |
| Monomer G | TFPA | | | | | | | | | | | | |
| Other | LA | 5.0 | 5.0 | 5.0 | 5.0 | 2.0 | 0.0 | 5.0 | 5.0 | 5.0 | 5.0 | 5.0 | 5.0 |
| monomer | TDA | 5.6 | 5.6 | 5.6 | 5.6 | 2.0 | 0.0 | 5.6 | 5.6 | 5.6 | 5.6 | 5.6 | 5.6 |
| | HDDA | 11.0 | 11.0 | 11.0 | 11.0 | 6.1 | 5.0 | 11.0 | 11.0 | 11.0 | 11.0 | 11.0 | 11.0 |
| Compound H | 3-MBA | 2.0 | 0.02 | 0.04 | 13.5 | 20.0 | 20.0 | | | | | | |
| | CyHex | | | | | | | | | | | | |
| | MEK | | | | | | | | | | | | |
| | AcOBu | | | | | | | 2.0 | | | | | |
| | Ethyl | | | | | | | | 2.0 | | | | |
| | acetoacetate | | | | | | | | | | | | |
| | Dibutyl | | | | | | | | | 2.0 | | | |
| | phthalate | | | | | | | | | | | | |
| | CyHex-OH | | | | | | | | | | 2.0 | | |
| | Dioxane | | | | | | | | | | | 2.0 | |
| | Cyclohexane | | | | | | | | | | | | 2.0 |
| | Styrene | | | | | | | | | | | | |
| | Butyl | | | | | | | | | | | | |
| | acrylate | | | | | | | | | | | | |

| | | | | | | | | | | | | |
|---|---|---|---|---|---|---|---|---|---|---|---|---|
| All monomers in ink | 69.1 | 68.7 | 68.7 | 68.7 | 57.2 | 52.1 | 68.7 | 68.7 | 68.7 | 68.7 | 68.7 | 68.7 |
| (parts by mass) | | | | | | | | | | | | |
| Content (mass %) of | 2.9 | 0.03 | 0.05 | 19.7 | 35.0 | 38.4 | 2.9 | 2.9 | 2.9 | 2.9 | 2.9 | 2.9 |
| compound H relative | | | | | | | | | | | | |
| to all monomers | | | | | | | | | | | | |
| Monomer A/all | 0.03 | 0.17 | 0.03 | 0.03 | 0.03 | 0.22 | 0.03 | 0.03 | 0.03 | 0.03 | 0.03 | 0.03 |
| monomers ratio | | | | | | | | | | | | |
| Monomer A/(monomer | 0.052 | 0.523 | 0.053 | 0.053 | 0.053 | 0.523 | 0.053 | 0.053 | 0.053 | 0.053 | 0.053 | 0.053 |
| B + | | | | | | | | | | | | |
| monomer C) ratio | | | | | | | | | | | | |
| Curability | 5 | 5 | 5 | 5 | 5 | 5 | 5 | 5 | 5 | 5 | 5 | 5 |
| Color-difference | 3 | 3 | 3 | 3 | 3 | 3 | 3 | 3 | 3 | 3 | 3 | 3 |
| weather resistance | | | | | | | | | | | | |
| (ΔE) | | | | | | | | | | | | |
| Adhesiveness over | A | B | A | A | A | B | A | A | A | A | A | A |
| time | | | | | | | | | | | | |
| Rubfastness over | A | B | A | A | A | B | A | A | A | A | A | A |
| time | | | | | | | | | | | | |

TABLE 4

| | | Example | | | | | | |
|---|---|---|---|---|---|---|---|---|
| | | 37 | 38 | 39 | 40 | 41 | 42 | 43 |
| Inorganic | Cyan mill base | 25.0 | 25.0 | | | | | |
| pigment | Magenta mill base | | | 25.0 | | | | |
| dispersion | Yellow mill base 1 | | | | 25.0 | | | |
| | Yellow mill base 2 | | | | | 25.0 | | |
| | White mill base | | | | | | 25.0 | |
| | Black mill base | | | | | | | 25.0 |
| Monomer A | DMAEA | 2.0 | 2.0 | 2.0 | 2.0 | 2.0 | 2.0 | 2.0 |
| | DEAEA | | | | | | | |
| | DEAEMA | | | | | | | |
| | PAEA | | | | | | | |
| Monomer B | PEA | 11.6 | 11.6 | 11.6 | 11.6 | 11.6 | 11.6 | 11.6 |
| | BnMA | | | | | | | |
| Monomer C | NVC | 14.0 | 14.0 | 14.0 | 14.0 | 14.0 | 14.0 | 14.0 |
| Monomer D | CyHA | 7.2 | 7.2 | 7.2 | 7.2 | 7.2 | 7.2 | 7.2 |
| | CTFA | | | | | | | |
| | IBOA | | | | | | | |
| Monomer E | GlyA | | | | | | | |
| | EPCHMA | | | | | | | |
| Monomer F | EOMA | | | | | | | |
| Monomer G | TFPA | | | | | | | |
| Other monomer | LA | 5.0 | 5.0 | 5.0 | 5.0 | 5.0 | 5.0 | 5.0 |
| | TDA | 5.6 | 5.6 | 5.6 | 5.6 | 5.6 | 5.6 | 5.6 |
| | HDDA | 11.0 | 11.0 | 11.0 | 11.0 | 11.0 | 11.0 | 11.0 |
| Compound H | 3-MBA | | | 2.0 | 2.0 | 2.0 | 2.0 | 2.0 |
| | CyHex | | | | | | | |
| | MEK | | | | | | | |
| | AcOBu | | | | | | | |
| | Ethyl acetoacetate | | | | | | | |
| | Dibutyl phthalate | | | | | | | |
| | CyHex-OH | | | | | | | |
| | Dioxane | | | | | | | |
| | Cyclohexane | | | | | | | |
| | Styrene | 2.0 | | | | | | |
| | Butyl acrylate | | 2.0 | | | | | |

| | | | | | | | |
|---|---|---|---|---|---|---|---|
| All monomers in ink (parts by mass) | 70.7 | 70.7 | 71.2 | 71.2 | 68.7 | 68.7 | 68.7 |
| Content (mass %) of compound H relative to all | 2.8 | 2.8 | 2.8 | 2.8 | 2.9 | 2.9 | 2.9 |
| monomers | | | | | | | |
| Monomer A/all monomers ratio | 0.03 | 0.03 | 0.03 | 0.03 | 0.03 | 0.03 | 0.03 |
| Monomer A/(monomer B + monomer C) ratio | 0.053 | 0.053 | 0.050 | 0.053 | 0.053 | 0.053 | 0.053 |
| Curability | 5 | 5 | 5 | 5 | 5 | 5 | 5 |
| Color-difference weather resistance (ΔE) | 3 | 3 | 3 | 3 | 3 | 2.5 | 2.5 |
| Adhesiveness over time | A | A | A | A | A | A | A |
| Rubfastness over time | A | A | A | A | A | A | A |

Notes on Table 1 to Table 4

In Tables, only inorganic pigment dispersions, polymerizable monomers, and compounds H in the composition of inks are shown, and components common to all examples (i.e., the photopolymerization initiators, the sensitizer, the polymerization inhibitor, the acrylic resin, and the silicone surfactant) are not shown.

The unit of numerical values for components is parts by mass.

Blanks in Tables each mean the absence of the corresponding component.

“All monomers in ink (parts by mass)” means the total content (parts by mass) of all polymerizable monomers contained in each ink. “All monomers in ink” also includes the monomer (specifically, 2-phenoxyethyl acrylate serving as a monomer B) in the inorganic pigment dispersion.

Monomer A is a polymerizable monomer having a basic group including a nitrogen atom,

Monomer B is a (meth)acrylate compound having an aromatic ring,

Monomer C is N-vinylcaprolactam,

Monomer D is a polymerizable monomer having an alicyclic structure,

Monomer E is a polymerizable monomer having an epoxy ring,

Monomer F is a polymerizable monomer having an oxetane ring,

Monomer G is polymerizable monomer having a fluorine atom, and

Compound H is at least one selected from the group consisting of organic solvents, alkyl (meth)acrylates having an alkyl group of 1 to 4 carbon atoms, and styrene optionally having a substituent other than a fluorine atom.

“Content (mass %) of compound H relative to all monomers” means the content (mass %) of a compound H relative to the total content of all polymerizable monomers contained in each ink.

“Monomer A/all monomers ratio” means the ratio of the mass content of a monomer A to the total mass content of all polymerizable monomers contained in each ink.

“Monomer A/(monomer B+monomer C) ratio” means the ratio of the mass content of a monomer A to the total mass content of a monomer B and a monomer C.

### Abbreviations in Table 1 to Table 4

DMAEA: dimethylaminoethyl acrylate

DEAEA: diethylaminoethyl acrylate

DEAEMA: diethylaminoethyl methacrylate

PAEA: N-phenylaminoethyl acrylate

PEA: 2-phenoxyethyl acrylate

BnMA: benzyl acrylate

NVC: N-vinylcaprolactam

CyHA: cyclohexyl acrylate

CTFA: cyclic trimethylolpropane formal acrylate

IBOA: isobornyl acrylate

GlyA: glycidyl acrylate

EPCHMA: 3,4-epoxycyclohexylmethyl methacrylate

EOMA: (3-ethyloxetan-3-yl)methyl acrylate

TFPA: 2,2,3,3-tetrafluoropropyl acrylate

LA: lauryl acrylate

TDA: tridecyl acrylate

HDDA: 1,6-hexanediol diacrylate

3MBA: 3-methoxybutyl acetate

CyHex: cyclohexanone

MEK: methyl ethyl ketone

AcOBu: butyl acetate

CyHex-OH: cyclohexanol

As shown in Table 1 to Table 4, in Examples in each of which an ink containing a monomer A that is a polymerizable monomer having a basic group including a nitrogen atom and an inorganic pigment including at least one element selected from the group consisting of cobalt, aluminum, iron, bismuth, vanadium, titanium, and carbon was used, the adhesiveness over time and rubfastness over time of images were high.

In Comparative Example 1 in which the ink did not contain a monomer A, the adhesiveness over time and rubfastness over time of an image were low. The reason why the adhesiveness over time and rubfastness over time of an image were low is probably as follows: since the ink did not contain a monomer A, hydrochloric acid generated as a result of decomposition of the polyvinyl chloride building material due to the passage of time could not be trapped.

The results of Example 5 and Example 7 show that when the basic group including a nitrogen atom is an aliphatic amino group (Example 5), color-difference weather resistance is further improved.

For example, the results of Example 9 and Example 10 show that when the ink contains a monomer D that is a polymerizable monomer having an alicyclic structure (Example 10), the rubfastness over time of an image is further improved.

The results of Example 14 to Example 19 show that when the ink further includes at least one compound selected from the group consisting of a monomer E that is a polymerizable monomer having an epoxy ring, a monomer F that is a polymerizable monomer having an oxetane ring, and a monomer G that is a polymerizable monomer containing a fluorine atom (Example 15 to Example 19), the adhesiveness over time and rubfastness over time of an image are further improved.

The results of Example 1 and Example 20 to Example 24 show that when the ratio of the mass content of a monomer A to the total mass content of a monomer B and a monomer C (i.e., the monomer A/(monomer B+monomer C) ratio) is 0.004 to 1 (Example 21 to Example 24), the adhesiveness over time and rubfastness over time of an image are further improved.

The results of Example 2 to Example 7 show that when a compound H that is at least one selected from the group consisting of organic solvents, alkyl (meth)acrylates having an alkyl group of 1 to 4 carbon atoms, and styrene optionally having a substituent is further contained (Example 5 to Example 7), the adhesiveness over time of an image is further improved.

The results of Example 25 to Example 30 show that when the content of a compound H is 0.05 mass % to 35 mass % relative to the total amount of polymerizable monomers (Example 25 and Example 27 to Example 29), the adhesiveness over time and rubfastness over time of an image are further improved.

The contents disclosed in JP2019-033755 filed in the Japan Patent Office on Feb. 27, 2019 are incorporated herein by reference in its entirety.

All documents, patent applications, and technical standards mentioned in this specification are incorporated herein by reference to the same extent as if each individual document, patent application, or technical standard was specifically and individually indicated to be incorporated by reference.

What is claimed is:

1. An ink jet ink composition for a polyvinyl chloride building material, comprising:
a monomer A that is a polymerizable monomer having a basic group including a nitrogen atom; and
an inorganic pigment including at least one element selected from the group consisting of cobalt, aluminum, iron, bismuth, vanadium, titanium, and carbon,
wherein the basic group including a nitrogen atom is a tertiary amino group.

2. The ink jet ink composition for a polyvinyl chloride building material according to claim 1, wherein the basic group including a nitrogen atom is an aliphatic amino group.

3. The ink jet ink composition for a polyvinyl chloride building material according to claim 1, wherein the inorganic pigment is at least one selected from the group consisting of C.I. pigment blue 28, C.I. pigment red 101, C.I. pigment yellow 42, C.I. pigment yellow 184, C.I. pigment white 6, and C.I. pigment black 7.

4. The ink jet ink composition for a polyvinyl chloride building material according to claim 1, further comprising a monomer B that is a (meth)acrylate compound having an aromatic ring.

5. The ink jet ink composition for a polyvinyl chloride building material according to claim 1, further comprising a monomer C that is N-vinylcaprolactam.

6. The ink jet ink composition for a polyvinyl chloride building material according to claim 1, further comprising a monomer B that is a (meth)acrylate compound having an aromatic ring and a monomer C that is N-vinylcaprolactam,
wherein a ratio of a mass content of the monomer A to a total mass content of the monomer B and the monomer C is 0.004 to 1.

7. The ink jet ink composition for a polyvinyl chloride building material according to claim 1, further comprising a monomer D that is a polymerizable monomer having an alicyclic structure.

8. The ink jet ink composition for a polyvinyl chloride building material according to claim 1, further comprising at least one selected from the group consisting of a monomer E that is a polymerizable monomer having an epoxy ring, a monomer F that is a polymerizable monomer having an oxetane ring, and a monomer G that is a polymerizable monomer containing a fluorine atom.

9. The ink jet ink composition for a polyvinyl chloride building material according to claim 1, further comprising a compound H that is at least one selected from the group consisting of organic solvents, alkyl (meth)acrylates having an alkyl group of 1 to 4 carbon atoms, and styrene optionally having a substituent other than a fluorine atom.

10. The ink jet ink composition for a polyvinyl chloride building material according to claim 9, wherein a content of the compound H is 0.05 mass % to 35 mass % relative to a total content of all polymerizable monomers contained in the ink jet ink composition for a polyvinyl chloride building material.

11. The ink jet ink composition for a polyvinyl chloride building material according to claim 1, further comprising a photopolymerization initiator.

12. An image recording method comprising:
applying the ink jet ink composition for a polyvinyl chloride building material according to claim 1 to a polyvinyl chloride building material by an ink jet method; and
irradiating the ink jet ink composition for a polyvinyl chloride building material applied to the polyvinyl chloride building material with an active radiation.

13. An image recorded article comprising:
a polyvinyl chloride building material; and
an image disposed on the polyvinyl chloride building material, the image being a cured product of the ink jet ink composition for a polyvinyl chloride building material according to claim 1.
